(19) United States
(12) Patent Application Publication
(10) Pub. No.: US 2002/0165868 A1
(43) Pub. Date: Nov. 7, 2002

(54) Retrieving method, retrieving system, retrieving program, retrieval objective map generating method, retrieval objective map generating system, image retrieving method, image retrieving system, image retrieving program, image retrieval data, image map generating method and image map generating system

(76) Inventor: Naoki Kayahara, Nagano-ken (JP)

Correspondence Address: Pillsbury Winthrop LLP, Intellectual Property Group, Suite 2800, 725 South Figueroa Street, Los Angeles, CA, 90017-5406, US

(21) Appl. No.: 09/821,328

(22) Filed: Mar. 29, 2001

(30) Foreign Application Priority Data
Mar. 29, 2000 (JP) 2000-92508
Mar. 29, 2000 (JP) 2000-92509
Dec. 28, 2000 (JP) 2000-401680

(51) Int. Cl. G06F 17/30

(52) U.S. Cl. 707/104.1; 707/3

(57) ABSTRACT

A graphic image retrieving system suitable for sensuous image of a hair style graphic image advantageous in view point of work load and time, is provided. An expression word map 60, in which a plurality of expression words are arranged on a virtual space 50 depending upon degree of association of sensuous image, and hair style graphic images jpg01 to jpg09 are stored with correspondence with the expression words. When graphic image map 80 is generated, coordinates of the expression word corresponding to each hair style graphic image jpg01 to jpg09 in the virtual space 50 is derived with reference to expression word map 60. On the basis of the given retrieving word, when sensuous image retrieval of the hair style graphic image is performed, the coordinates of the retrieving word in the virtual space 50 is derived with reference to the expression word map 60. With reference to the graphic image map 80, the hair style graphic image of the sensuous image meeting with sensuous image of the retrieving word is retrieved among a plurality of hair style graphic images on the basis of the derived coordinates.

### BACKGROUND OF THE INVENTION

1. Field of the Invention

The present invention relates generally to a method, a system and a program for retrieving a retrieval object of an sensuous image adapted to an image of a retrieving word among a plurality of retrieval objects using sensuous expression word, such as adjective or the like. More particularly, the invention relates to a method, a system and a program for image retrieval of hair style sensuous images. Further particularly, the invention relates to a retrieving method, a retrieving system, a retrieving program, a retrieval object map generating method, a retrieval object map generating system, an image retrieving method, an image retrieving system, an image retrieving program, an image retrieval data, an image map generating method and an image map generating system suitable for performing image retrieval of retrieving object advantageous in view of work load and time.

2. Description of the Related Art

Many of industrial designers and planers creating new design on the basis of new product concept have demands to establish sensuous image database by accumulating large amount of graphic image of pictures, photographs and so forth and to permit quick access of a graphic image meeting own sensuous image as required. In this case, it should be quite convenient to permit retrieval with sensuous expression word, such as “warm”, “modern” expressing graphic images.

Conventionally, systems for retrieving graphic images meeting with sensuous image of retrieval word among a plurality of sensuous images using sensuous expression word as retrieval word, have been disclosed in Japanese Patent Application Laid-Open No. Showa 64-73460, for “Sensuous image Retrieving Apparatus” and Japanese Patent Application Laid-Open No. Showa 63-98025, for “Sensuous image Retrieving System”, for example.

The sensuous image retrieving apparatus disclosed in Japanese Patent Application Laid-Open No. Showa 64-73460 is constructed with an sensuous image storage portion storing a plurality of graphic images, an expression word attribute storage portion storing factor loading amount, a graphic image attribute storage portion storing factor points, an input portion inputting expression word expressing graphic image to be object for retrieval, an sensuous image identifying portion identifying a retrieval object sensuous image and a graphic image display portion displaying an sensuous image identified by the sensuous image identifying portion using stored information of the sensuous image storage portion.

The expression word attribute storage portion extracts small number of factors having common feeling from a plurality of expression word expressing sensuous image given from the graphic image and stores degree of association of the expression word and each factor as factor loading amount.

The sensuous image attribute storage portion stores degree of association between the graphic image and each factor as factor point with respect to each of a plurality of graphic images.

The sensuous image identifying portion derives the factor loading amount of the expression word input by the input portion with reference to the stored information of the expression word attribute storage portion and identifies the retrieval object graphic image with reference to the stored information of the graphic image attribute storage portion on the basis of the factor loading amount.

By this, easy and quick retrieval of the graphic image meeting with the sensuous image of the expression work, using the sensuous expression word expressing the graphic image imaginarily.

On the other hand, the sensuous image retrieving system disclosed in the Japanese Patent Application Laid-Open No. Showa 63-98025 establishes database of various graphic images and utilizes in diagnosis, analysis and so forth, wherein the user writes memo relating to the graphic image content in a graphic image on a CRT display screen to extract retrieval key from the memo for retrieving the graphic image similar to the graphic image content by the retrieval key.

By this, the retrieval key depending upon the graphic image content can be set without troubling the user. As a result, similar graphic image retrieval can be realized.

As set forth above, in the conventional sensuous image retrieving apparatus, degree of association between the graphic image and each factor has to be preliminarily stored as factor point for each of large number of graphic images.

However, in order to derive the degree of association between the graphic image and each factor for respective of large number of sensuous images, the graphic images to be the retrieval objects have to be mapped in a virtual space of coordinate system having respective factor axes in one by one basis. Since this virtual space is an amount as quantizing an impression given from the expression word assigned on each virtual factor axis, it requires a quite sensuous judgment for mapping operation on the virtual space. Therefore, automating of the mapping operation is quite difficult. In practice, mapping operation is performed manually. Accordingly, when number of sensuous images to be retrieval object becomes huge, huge amount of work load and time is required for mapping operation.

On the other hand, in the conventional sensuous image retrieving system, the retrieval key is extracted from the memo and retrieval of the graphic image similar to the sensuous image content is performed by the retrieval key. Therefore, a target sensuous image cannot be retrieved unless the retrieval word matches completely with the retrieval key extracted from the memo. Namely, the graphic image of the feeling matching with the sensuous image of the retrieval word can be retrieved. In order to realize this, for one graphic image, possible all expression words of the graphic image adapting to the impression to be given have to be written on the memo to require significant work load and time therefor.

The similar problem is expected not only in sensuous image retrieval of the graphic image but also in sensuous image retrieval of retrieval object, such as document, music, moving picture and so forth.

By the way, in barber shop and beauty shop, hair cutting is performed to realize a hair style receiving order for the hair style from a customer. In many cases, the customer selects and orders favorite hair style among hair styles placed in magazine or the like furnished in the shops. However, due to diversification of hair styles in the recent years, range of the hair styles to be selected by the customer becomes more and more wider to be advantageous for the customer. However, difficulty may be encountered in finding out desired hair style among huge number of hair styles in a short waiting period. Therefore, as set forth above, it should be quite convenient to apply a technology for retrieving graphic image meeting with the sensuous image of the retrieving word among a plurality of sensuous images using sensuous expression word as retrieving word. Namely, using the expression word expressing the hair style sensuous imaged by the customer, the graphic image of the hair style can be easily and quickly retrieved to find out the desired hair style even in short waiting period.

### SUMMARY OF THE INVENTION

The present invention is worked out in view of unsolved problem in the prior art. A first object of the present invention provides a retrieving method, a retrieving system, a retrieving program, a retrieval object map generating method, a retrieval object map generating system, an sensuous image retrieving method, an sensuous image retrieving system, an sensuous image retrieving program, an sensuous image retrieval data, an sensuous image map generating method and an sensuous image map generating system, suitable for performing sensuous image retrieval of retrieval object advantageous in viewpoint of work load or time. A second object of the present invention is to provide a retrieving method, a retrieving system, a retrieving program, a retrieval object map generating method, a retrieval object map generating system, an sensuous image retrieving method, an sensuous image retrieving system, an sensuous image retrieving program, an sensuous image retrieval data, an sensuous image map generating method and an sensuous image map generating system suitable for finding out desired hair style.

In order to achieve the above-mentioned object, a retrieving method defined in claim 1, according to the present invention is a method for retrieving retrieval object of sensuous image meeting with sensuous image of retrieving word among a plurality of retrieval objects on the basis of a given retrieving word, comprising storing an expression word map, in which a plurality of expression word expressing sensuous images of retrieval objects on a virtual space depending upon degree of association of those sensuous images are arranged, and storing the plurality of retrieval objects and including a first position deriving step of deriving the expression word corresponded to the retrieval object or position of the expression word contained in each of the retrieving object in the virtual space, a retrieving object map generation step of generating a retrieval object map arranging the respective retrieval objects on the virtual space on the basis of position derived at the first position deriving step, a second position deriving step of deriving position of the retrieving word on the virtual space with reference to the expression word, and retrieval object retrieving step of retrieving the retrieval object of sensuous image meeting with sensuous image of the retrieving word among a plurality of retrieval objects on the basis of the position derived at the second position deriving step with reference to the retrieval object map.

Here, the expression word map may be any data structure as long as a plurality of expression words are arranged on the virtual space depending upon degree of association of the sensuous image. For example, it can be constructed with a table the expression word and the its position in the virtual space with correspondence. On the other hand, in the expression word map, each expression word is arranged in the virtual space to be closer at higher degree of association of the sensuous image and greater distance at lower degree of association of the sensuous image, or vice versus. The same is true in retrieving system defined in claim 6,, retrieving program defined in claim 11, retrieval object map generating method defined in claim 12, retrieval object map generating system defined in claim 15.

On the other hand, the retrieval objective map may be any data structure as long as respective retrieval objects are arranged on the virtual space. For example, it can be constructed with a table the expression word and the its position in the virtual space with correspondence. On the other hand, in the retrieval object map, each retrieval object is arranged in the virtual space at the same position as the expression word included in each retrieval object. Each retrieval object is arranged on the virtual space depending upon degree of association of the sensuous image. The same is true in retrieving system defined in claim 6, retrieving program defined in claim 11, retrieval object map generating method defined in claim 12, retrieval object map generating system defined in claim 15.

On the other hand, the retrieval object map is not limited to directly arrange respective retrieval objects on the virtual space but can be indirectly arranged respective retrieval objects on the virtual space. In the latter case, for example, the retrieval object and certain data are corresponded, and the data is arranged on the virtual space. Of course, by interposing data between the virtual space and the retrieval object, and those are associated not only in two levels but also in multiple levels. For example, considering the case of association in three levels, the retrieval object and the first data are corresponded, the first data and the second data are corresponded, and the second data is arranged on the virtual space. The same is true in retrieving system defined in claim 6, retrieving program defined in claim 11, retrieval object map generating method defined in claim 12, retrieval object map generating system defined in claim 15.

On the other hand, when each retrieval object is corresponded to the expression word, each retrieval object is not limited to store with correspondence to one expression word, but can be corresponded to two or more expression words. In the latter case, in the retrieval object map, the same retrieval object can be arranged at a plurality of positions in the virtual space. In the alternative, position to be representative is determined from the position of each expression word, the retrieval object may be arranged at the representative position. The same is true in retrieving system defined in claim 6, retrieving program defined in claim 11, retrieval object map generating method defined in claim 12, retrieval object map generating system defined in claim 15.

On the other hand, each retrieval object includes the expression word, each retrieval object is not limited to contain one expression word but may contain two or more expression words. In the latter case, in the retrieval object, the same retrieval object may be arranged at a plurality of positions. In the alternative, position to be representative is determined from the position of each expression word, the retrieval object may be arranged at the representative position. The same is true in retrieving system defined in claim 6, retrieving program defined in claim 11, retrieval object map generating method defined in claim 12, retrieval object map generating system defined in claim 15.

On the other hand, the virtual space can be expressed by the coordinate system having one, or two or more axes. In this case, on each axis, size of sense as quantified is assigned. In the alternative, position to be representative is determined from the position of each expression word, the retrieval object may be arranged at the representative position. The same is true in retrieving system defined in claim 6, retrieving program defined in claim 11, retrieval object map generating method defined in claim 12, retrieval object map generating system defined in claim 15.

On the other hand, as the retrieval object, graphic image, document, music, moving picture and other retrieval object may be included, for example. Namely, upon performing sensuous image retrieval of the retrieval object, application of the present invention is preferred. In the alternative, position to be representative is determined from the position of each expression word, the retrieval object may be arranged at the representative position. The same is true in retrieving system defined in claim 6, retrieving program defined in claim 11, retrieval object map generating method defined in claim 12, retrieval object map generating system defined in claim 15.

Furthermore, in the retrieving method as defined in claim 2, according to the present invention, the retrieval object retrieving step retrieves the retrieval object at a position having smaller distance to a position derived at the second position deriving step in the virtual space with reference to the retrieval object map in ascending order.

Here, in retrieval according to the present invention, there are following four modes.

At first, in the first mode, when each retrieval object is arranged at one position in the virtual space in the retrieval object map, the retrieving word is given from one expression word. In this case, as the retrieving method of the retrieving object, a distance between the position of the retrieving word in the virtual space and the position of each retrieval object is derived to retrieve the retrieval object having smaller derived distance in ascending order.

In the second mode, when each retrieval object is arranged at one position in the virtual space in the retrieval object map, the retrieving word containing two or more expression words are given. In this case, as the retrieving method of the retrieving object, a distance between the position of the retrieving word in the virtual space and the position of each retrieval object is derived to retrieve the retrieval object having smaller derived distance in ascending order.

In the third mode, when each retrieval object is arranged at a plurality of positions in the virtual space in the retrieval object map, the retrieving word is given from one expression word. In this case, as the retrieving method of the retrieving object, a distance between the position of the retrieving word in the virtual space and the position of each of retrieval objects is derived and a distance to be representative of the derived distances (e.g. average of respective distances) to retrieve the retrieval object having smaller derived distance in ascending order.

In the fourth mode, when each retrieval object is arranged at one position in the virtual space in the retrieval object map, the retrieving word containing two or more expression words are given. In this case, as the retrieving method of the retrieving object, a distance between the position of the retrieving word in the virtual space and the position of each of retrieval objects is derived and a distance to be representative of the derived distances to retrieve the retrieval object having smaller derived distance in ascending order.

The same is true in the retrieving system defined in claim 6.

Furthermore, in the retrieving method as defined in claim 3, according to the present invention, the retrieving method as set forth in claim 1, wherein the retrieval object retrieving step retrieves the retrieval object at a position having smaller angle defined by a straight line connecting a position in the virtual space derived by the second position deriving step and an origin of the virtual space and a straight line connecting a position of the retrieving object in the virtual space and the origin of the virtual space, with reference to the retrieval object map in ascending order.

Here, concerning four modes set forth in the portion of the retrieving method defined in claim 2, when the retrieving object is retrieved by the retrieving method of claim 4, it can be considered to be similar by replacing the distance with angle.

Furthermore, in the retrieving method as defined in claim 4, according to the present invention, the retrieving method as set forth in any one of claims 1 to 3, wherein the retrieval object is data including the expressing word, and the method comprises expression word extracting step of extracting the expression word from the retrieval object and expression word correspondence step of storing the retrieval object with correspondence with the expression word extracted in the expression word extracting step.

Furthermore, in the retrieving method as defined in claim 5, according to the present invention, the retrieving method as set forth in any one of claims 1 to 4, wherein the retrieval objects are stored with attribute information indicative of attributes of the retrieval object, the method comprises second retrieval object retrieving step of retrieving retrieval object corresponding to attribute information matching with a given attribute information among the plurality of retrieval objects on the basis of the given attribute information, the retrieval object retrieving step retrieves the retrieval object of sensuous image meeting with sensuous image of the retrieving word among retrieval objects retrieved at the second retrieval object retrieving step.

Here, as kinds of the attribute, if the retrieval object is hair style, for example, technical words, length of hair, event to which the hair style is suited (e.g. graduation ceremony, coming-of-age ceremony), facial form representative of shape of face, personal type indicative of personality type of the hair style and hair quality. Among these kind, length of hair is exemplified, very short, short medium, semi long, long and so forth as attribute are considered. This is true in retrieving system defined in claim 10, retrieval object map generating method defined in claim 14, retrieving object map generating system defined in claim 17, graphic image retrieving method defined in claim 21, graphic image retrieving system defined in claim 25, graphic image map generating method defined in claim 36 and graphic image map generating system defined in claim 39.

On the other hand, in order to achieve the above-mentioned object, in a retrieving system as defined in claim 6, according to the present invention, the system for retrieving retrieval object of sensuous image meeting with sensuous image of retrieving word among a plurality of retrieval objects on the basis of a given retrieving word, comprising expression word map storage means for storing an expression word map, in which a plurality of expression word expressing sensuous images of retrieval objects on a virtual space depending upon degree of association of those sensuous images are arranged, retrieval object storage means for storing the plurality of retrieving objects, first position deriving means for deriving the expression word corresponded to the retrieval object or position of the expression word contained in each of the retrieving object in the virtual space, a retrieving object map generation means for generating a retrieval object map arranging the respective retrieval objects on the virtual space on the basis of position derived at the first position deriving means, a second position deriving means for deriving position of the retrieving word on the virtual space with reference to the expression word, and retrieval object retrieving means for retrieving the retrieval object of sensuous image meeting with sensuous image of the retrieving word among a plurality of retrieval objects on the basis of the position derived at the second position deriving means with reference to the retrieval object map.

With such construction, when each retrieval object is corresponded to the expression word, the position of the expression word corresponded to each retrieval object in the virtual space is derived by the first position deriving means with reference to the expression word map, and the retrieval object map is generated by the retrieval object map generating means on the basis of the derived positions. In the retrieval object map, each retrieval object of the retrieval object storage means is arranged in the virtual space.

When each retrieval object contains the expression word, the position of the expression word contained in each retrieval object in the virtual space is derived by the first position deriving means with reference to the expression word map, and the retrieval object map is generated by the retrieval object map generating means on the basis of the derived positions. In the retrieval object map, each retrieval object of the retrieval object storage means is arranged in the virtual space.

Next, when the retrieving word is given, the position of the retrieving word in the virtual space is derived with reference to the expression word map, and the retrieval object of the sensuous image meeting with the sensuous image of the retrieval object is retrieved among the retrieval object storage means on the basis of the derived position with reference to the retrieval object map.

Here, generation of the retrieval object map may be performed before the retrieval word is given or after the retrieval object is give. The same is true in the retrieving program defined in claim 11.

Furthermore, in the retrieving system as defined in claim 7, according to the present invention, the retrieving system as set forth in claim 6, wherein the retrieval object retrieving means retrieves the retrieval object at a position having smaller distance to a position derived at the second position deriving means in the virtual space with reference to the retrieval object map in ascending order.

With such construction, the retrieval object at the position having smaller distance to the derived retrieving word are retrieved in ascending order by the retrieval object retrieving means.

Furthermore, in the retrieving system as defined in claim 8, according to the present invention, the retrieving system as set forth in claim 6, wherein the retrieval object retrieving means retrieves the retrieval object at a position having smaller angle defined by a straight line connecting a position in the virtual space derived by the second position deriving means and an origin of the virtual space and a straight line connecting a position of the retrieving object in the virtual space and the origin of the virtual space, with reference to the retrieval object map.

With such construction, the retrieval object retrieving means retrieves the retrieval object at a position having smaller angle defined by a straight line connecting a position in the virtual space and an origin of the virtual space and a straight line connecting a position of the retrieving object in the virtual space and the origin of the virtual space, with reference to the retrieval object map in ascending order by the retrieval object retrieving means.

Furthermore, in the retrieving system as defined in claim 9, according to the present invention, the retrieving system as set forth in any one of claims 6 to 8, wherein the retrieval object is data including the expressing word, and the system comprises expression word extracting means for extracting the expression word from the retrieval object and expression word correspondence means for storing the retrieval object with correspondence with the expression word extracted in the expression word extracting means.

With the construction set forth above, by the expression word extracting means, the expression word is extracted from the retrieval object, and by the expression word correspondence means, the retrieval object is stored in the retrieval object storage means with correspondence to the extracted expression word.

Furthermore, in the retrieving system as defined in claim 10, according to the present invention, the retrieving system as set forth in any one of claims 6 to 9, wherein the retrieval objects are stored with attribute information indicative of attributes of the retrieval object, the system comprises second retrieval object retrieving means for retrieving retrieval object corresponding to attribute information matching with a given attribute information among the plurality of retrieval objects on the basis of the given attribute information, the retrieval object retrieving means retrieves the retrieval object of sensuous image meeting with sensuous image of the retrieving word among retrieval objects retrieved by the retrieval object retrieving means.

With the construction set forth above, when attribute information is given, the retrieval object corresponding to the attribute information matching with a given attribute information among the plurality of retrieval objects on the basis of the given attribute information by the second position deriving means. Then, retrieving word is given, the retrieval object of sensuous image meeting with sensuous image of the retrieving word among retrieval objects by retrieval object retrieving means.

On the other hand, in order to accomplish the above-mentioned object, a retrieving program defined in claim 11, according to the present invention, the retrieving program for retrieving retrieval object of sensuous image meeting with sensuous image of retrieving word among a plurality of retrieval objects on the basis of a given retrieving word, for a computer comprising expression word map storage means for storing an expression word map, in which a plurality of expression word expressing sensuous images of retrieval objects on a virtual space depending upon degree of association of those sensuous images are arranged, retrieval object storage means for storing the plurality of retrieving objects, the program making to execute a process realized by first position deriving means for deriving the expression word corresponded to the retrieval object or position of the expression word contained in each of the retrieving object in the virtual space, a retrieving object map generation means for generating a retrieval object map arranging the respective retrieval objects on the virtual space on the basis of position derived at the first position deriving means, a second position deriving means for deriving position of the retrieving word on the virtual space with reference to the expression word, and retrieval object retrieving means for retrieving the retrieval object of sensuous image meeting with sensuous image of the retrieving word among a plurality of retrieval objects on the basis of the position derived at the second position deriving means with reference to the retrieval object map.

With such construction, the program is read out by the computer, and when the read out program is executed by the computer, operation equivalent to the retrieving system defined in claim 6 can be obtained.

On the other hand, in order to accomplish the above-mentioned object, a retrieval object map generating method defined in claim 12 according to the present invention, the method for generating a retrieval object map to be used for a method of retrieving retrieval object of sensuous image meeting with sensuous image of retrieving word among a plurality of retrieval objects on the basis of a given retrieving word using the retrieval object map, in which a plurality of expression word expressing sensuous images of retrieval objects on a virtual space depending upon degree of association of those sensuous images are arranged, comprising storing an expression word map, in which a plurality of expression word expressing sensuous images of retrieval objects on a virtual space depending upon degree of association of those sensuous images are arranged, and storing the plurality of retrieval objects with correspondence to the expression words and including a first position deriving step of deriving the expression word corresponded to the retrieval object or position of the expression word contained in each of the retrieving object in the virtual space, and a retrieving object map generation step of generating a retrieval object map arranging the respective retrieval objects on the virtual space on the basis of position derived at the first position deriving step.

Furthermore, in the retrieval object map generating method as defined in claim 13, according to the present invention, the retrieval object map generating method as set forth in claim 12, wherein the retrieval object is stored with correspondence with a retrieval object describing document as descriptive text for the retrieval object and describing sensuous image of the retrieval object and a supplementary document including the expression word supplementing the retrieval object descriptive document, the method comprises expression word extracting step of extracting the expression word from the retrieval object descriptive document and the supplementary document corresponding to the retrieval object with reference to the expression word map, the first position deriving step derives the position of the expression word extracted at the expression word extracting step with reference to the expression word map.

Furthermore, in the retrieval object map generating method as defined in claim 14, according to the present invention, the retrieval object map generating method as set forth in claim 13, wherein each of the retrieval objects is stored with correspondence with an attribute information indicative of the retrieval object in addition to the retrieval object descriptive object and the supplementary document.

On the other hand, in order to accomplish the above-mentioned object, a retrieval object map generating system defined in claim 15, according to the present invention, the system for generating a retrieval object map to be used for a system of retrieving retrieval object of sensuous image meeting with sensuous image of retrieving word among a plurality of retrieval objects on the basis of a given retrieving word using the retrieval object map, in which a plurality of expression word expressing sensuous images of retrieval objects on a virtual space depending upon degree of association of those sensuous images are arranged, comprising expression word storage means for storing an expression word map, in which a plurality of expression word expressing sensuous images of retrieval objects on a virtual space depending upon degree of association of those sensuous images are arranged, retrieval object storage means for storing the plurality of retrieval objects with correspondence to the expression words, a first position deriving means for deriving the expression word corresponded to the retrieval object or position of the expression word contained in each of the retrieving object in the virtual space, and a retrieving object map generation means for generating a retrieval object map arranging the respective retrieval objects on the virtual space on the basis of position derived at the first position deriving step.

With the construction set forth above, by the first position deriving means, the position of the expression word in the retrieval object storage means in the virtual space is derived with reference to the expression word, and by the retrieval object map generating means, the retrieval object map is generated on the basis of the derived position. In the retrieval object map, each retrieval object of the retrieval object storage means is arranged on the virtual space.

Furthermore, in the retrieval object map generating method as defined in claim 16, according to the present invention, the retrieval object map generating system as set forth in claim 15, wherein the retrieval object storage means stores each of the retrieval object with correspondence with a retrieval object describing document as descriptive text for the retrieval object and describing sensuous image of the retrieval object and a supplementary document including the expression word supplementing the retrieval object descriptive document, the system comprises expression word extracting means for extracting the expression word from the retrieval object descriptive document and the supplementary document corresponding to the retrieval object with reference to the expression word map, the first position deriving means derives the position of the expression word extracted at the expression word extracting step with reference to the expression word map.

With the construction set forth above, by the expression word extracting means, the expression word is extracted from the retrieval object descriptive document and the supplementary document corresponding to each retrieval object with reference to the expression word map, and by the first position deriving means, the position of the extracted expression word is derived in the virtual space.

Furthermore, in the retrieval object map generating method as defined in claim 17, according to the present invention, the retrieval object map generating system as set forth in claim 16, wherein each of the retrieval objects is stored with correspondence with an attribute information indicative of the retrieval object in addition to the retrieval object descriptive object and the supplementary document.

With the construction set forth above, in the retrieval object map, each retrieval object of the retrieval object storage means is arranged in the virtual space with correspondence with the attribute information.

On the other hand, in order to accomplish the above-mentioned object, the graphic image retrieving method defined in claim 18, according to the present invention, the method for retrieving graphic image of sensuous image meeting with sensuous image of retrieving word among a plurality of graphic images on the basis of a given retrieving word, comprising storing an expression word map, in which a plurality of expression word expressing sensuous images of graphic images on a virtual space depending upon degree of association of those sensuous images are arranged, and storing the plurality of graphic images, and including a first position deriving step of deriving the expression word corresponded to the graphic image or position of the expression word contained in each of the graphic image in the virtual space, a graphic image map generation step of generating a graphic image map arranging the respective graphic images on the virtual space on the basis of position derived at the first position deriving step, a second position deriving step of deriving position of the retrieving word on the virtual space with reference to the expression word, and graphic image retrieving step of retrieving the graphic image of sensuous image meeting with sensuous image of the retrieving word among a plurality of graphic images on the basis of the position derived at the second position deriving step with reference to the graphic image map.

Here, the expression word map may be any data structure as long as a plurality of expression words are arranged on the virtual space depending upon degree of association of the sensuous image. For example, it can be constructed with a table the expression word and the its position in the virtual space with correspondence. On the other hand, in the expression word map, each expression word is arranged in the virtual space to be closer at higher degree of association of the sensuous image and greater distance at lower degree of association of the sensuous image, or vice versus. The same is true in retrieving system defined in claim 6,, retrieving program defined in claim 11, graphic image map generating method defined in claim 12, graphic image map generating system defined in claim 15.

On the other hand, the graphic image map may be any data structure as long as respective graphic images are arranged on the virtual space. For example, it can be constructed with a table the expression word and the its position in the virtual space with correspondence. On the other hand, in the graphic image map, each graphic image is arranged in the virtual space at the same position as the expression word included in each graphic image. Each graphic image is arranged on the virtual space depending upon degree of association of the sensuous image. The same is true in graphic image retrieving system defined in claim 22, graphic image retrieving program defined in claim 29, graphic image retrieving data defined in claim 30 or 31, graphic image map generating method defined in claim 34 and graphic image map generating system defined in claim 37.

On the other hand, the graphic image map is not limited to directly arrange respective graphic images on the virtual space but can be indirectly arranged respective graphic images on the virtual space. In the latter case, for example, the graphic image and certain data are corresponded, and the data is arranged on the virtual space. Of course, by interposing data between the virtual space and the graphic image, and those are associated not only in two levels but also in multiple levels. For example, considering the case of association in three levels, the graphic image and the first data are corresponded, the first data and the second data are corresponded, and the second data is arranged on the virtual space. The same is true in graphic image retrieving system defined in claim 22, graphic image retrieving program defined in claim 29, graphic image retrieving data defined in claim 30 or 31, graphic image map generating method defined in claim 34 and graphic image map generating system defined in claim 37.

On the other hand, each graphic image is not limited to store with correspondence to one expression word, but can be corresponded to two or more expression words. In the latter case, in the graphic image map, the same graphic image can be arranged at a plurality of positions in the virtual space. In the alternative, position to be representative is determined from the position of each expression word, the graphic image may be arranged at the representative position. The same is true in graphic image retrieving system defined in claim 22, graphic image retrieving program defined in claim 29, graphic image retrieving data defined in claim 30 or 31, graphic image map generating method defined in claim 34 and graphic image map generating system defined in claim 37.

On the other hand, the virtual space can be expressed by the coordinate system having one, or two or more axes. In this case, on each axis, size of sense as quantified is assigned. In the alternative, position to be representative is determined from the position of each expression word, the graphic image may be arranged at the representative position. The same is true in graphic image retrieving system defined in claim 22, graphic image retrieving program defined in claim 29, graphic image retrieving data defined in claim 30 or 31, graphic image map generating method defined in claim 34 and graphic image map generating system defined in claim 37.

Furthermore, in the graphic image retrieving method as defined in claim 19, according to the present invention, the retrieval object map generating system as set forth in claim 18, wherein the graphic image retrieving step retrieves the graphic image at a position having smaller distance to a position derived at the second position deriving step in the virtual space with reference to the graphic image map in ascending order.

Here, in retrieval according to the present invention, there are following four modes.

At first, in the first mode, when each graphic image is arranged at one position in the virtual space in the graphic image map, the retrieving word is given from one expression word. In this case, as the retrieving method of the graphic image, a distance between the position of the retrieving word in the virtual space and the position of each graphic image is derived to retrieve the graphic image having smaller derived distance in ascending order.

In the second mode, when each graphic image is arranged at one position in the virtual space in the graphic image map, the retrieving word containing two or more expression words are given. In this case, as the retrieving method of the graphic image, a distance between the position of the retrieving word in the virtual space and the position of each graphic image is derived to retrieve the graphic image having smaller derived distance in ascending order.

In the third mode, when each graphic image is arranged at a plurality of positions in the virtual space in the graphic image map, the retrieving word is given from one expression word. In this case, as the retrieving method of the graphic image, a distance between the position of the retrieving word in the virtual space and the position of each of graphic images is derived and a distance to be representative of the derived distances (e.g. average of respective distances) to retrieve the graphic image having smaller derived distance in ascending order.

In the fourth mode, when each graphic image is arranged at one position in the virtual space in the graphic image map, the retrieving word containing two or more expression words are given. In this case, as the retrieving method of the graphic image, a distance between the position of the retrieving word in the virtual space and the position of each of graphic images is derived and a distance to be representative of the derived distances to retrieve the graphic image having smaller derived distance in ascending order.

The same is true in the graphic image retrieving system defined in claim 23.

Furthermore, in the graphic image retrieving method as defined in claim 20, according to the present invention, the retrieval object map generating system as set forth in claim 18, wherein the graphic image retrieving step retrieves the graphic image at a position having smaller angle defined by a straight line connecting a position in the virtual space derived by the second position deriving step and an origin of the virtual space and a straight line connecting a position of the graphic image in the virtual space and the origin of the virtual space, with reference to the graphic image map in ascending order.

Here, concerning four modes set forth in the portion of the retrieving method defined in claim 19, when the retrieving object is retrieved by the retrieving method of claim 20, it can be considered to be similar by replacing the distance with angle. The same is true in the graphic image retrieving system defined in claim 24.

Furthermore, in the graphic image retrieving method as defined in claim 21, according to the present invention, the retrieval object map generating system as set forth in any one of claims 18 to 20, wherein each of the graphic image is stored with correspondence with an attribute information indicative of attribute of the graphic image, the method comprises second graphic image retrieving step of retrieving graphic image corresponding to attribute information matching with a given attribute information among the plurality of graphic images on the basis of the given attribute information, the graphic image retrieving step retrieves the graphic image of sensuous image meeting with sensuous image of the retrieving word among graphic images retrieved at the second graphic image retrieving step.

On the other hand, in order to accomplish the above-mentioned object, the graphic image retrieving system defined in claim 22, according to the present invention, the system for retrieving graphic image of sensuous image meeting with sensuous image of retrieving word among a plurality of graphic images on the basis of a given retrieving word, comprising expression word map storage means for storing an expression word map, in which a plurality of expression word expressing sensuous images of graphic images on a virtual space depending upon degree of association of those sensuous images are arranged, graphic image storage means for storing the plurality of graphic images, first position deriving means for deriving the expression word corresponded to the graphic image or position of the expression word contained in each of the graphic image in the virtual space, a graphic image map generation means for generating a graphic image map arranging the respective graphic images on the virtual space on the basis of position derived at the first position deriving means, a second position deriving means for deriving position of the retrieving word on the virtual space with reference to the expression word, and graphic image retrieving means for retrieving the graphic image of sensuous image meeting with sensuous image of the retrieving word among a plurality of graphic images on the basis of the position derived at the second position deriving means with reference to the graphic image map.

With such construction, when each graphic image is corresponded to the expression word, the position of the expression word corresponded to each graphic image in the virtual space is derived by the first position deriving means with reference to the expression word map, and the graphic image map is generated by the graphic image map generating means on the basis of the derived positions. In the graphic image map, each graphic image of the graphic image storage means is arranged in the virtual space.

Next, when the retrieving word is given, the position of the retrieving word in the virtual space is derived with reference to the expression word map, and the graphic image of the sensuous image meeting with the sensuous image of the graphic image is retrieved among the graphic image storage means on the basis of the derived position with reference to the graphic image map.

Here, generation of the graphic image map may be performed before the retrieval word is given or after the graphic image is give. The same is true in the retrieving program defined in claim 29.

Furthermore, in the graphic image retrieving system as defined in claim 23, according to the present invention, the graphic image retrieving system as set forth in claim 22, wherein the graphic image retrieving means retrieves the graphic image at a position having smaller distance to a position derived at the second position deriving means in the virtual space with reference to the graphic image map in ascending order.

With such construction, the retrieval object at the position having smaller distance to the derived retrieving word are retrieved in ascending order by the retrieval object retrieving means.

Furthermore, in the graphic image retrieving system as defined in claim 24, according to the present invention, the retrieving system as set forth in claim 22, wherein the graphic image retrieving means retrieves the graphic image at a position having smaller angle defined by a straight line connecting a position in the virtual space derived by the second position deriving means and an origin of the virtual space and a straight line connecting a position of the graphic image in the virtual space and the origin of the virtual space, with reference to the graphic image map.

With such construction, the retrieval object retrieving means retrieves the retrieval object at a position having smaller angle defined by a straight line connecting a position in the virtual space and an origin of the virtual space and a straight line connecting a position of the retrieving object in the virtual space and the origin of the virtual space, with reference to the retrieval object map in ascending order by the retrieval object retrieving means.

Furthermore, in the graphic image retrieving system as defined in claim 25, according to the present invention, the retrieving system as set forth in any one of claims 22 to 24, wherein the graphic images are stored with attribute information indicative of attributes of the graphic image, the system comprises second graphic image retrieving means for retrieving graphic image corresponding to attribute information matching with a given attribute information among the plurality of graphic images on the basis of the given attribute information, the graphic image retrieving means retrieves the graphic image of sensuous image meeting with sensuous image of the retrieving word among graphic images retrieved at the second graphic image retrieving means.

With the construction set forth above, when attribute information is given, the retrieval object corresponding to the attribute information matching with a given attribute information among the plurality of retrieval objects on the basis of the given attribute information by the second position deriving means. Then, retrieving word is given, the retrieval object of sensuous image meeting with sensuous image of the retrieving word among retrieval objects by retrieval object retrieving means.

Furthermore, in the graphic image retrieving system as defined in claim 26, according to the present invention, the retrieving system as set forth in any one of claims 22 to 25, which is applied for retrieval of hair style graphic images expressing hair styles.

With the construction set forth above, by the first position deriving means, the position of the expression word of the graphic image storage means is derived with reference to the expression map, and by the graphic image map generating means, the graphic image map is generated on the basis of the derived position. In the graphic image map, respective hair style graphic images of the graphic image storage means is arranged in the virtual space.

Next, when the retrieving word is given, the position of the retrieving word in the virtual space is derived with reference to the expression word map, and the hair style graphic image of the sensuous image meeting with the sensuous image of the hair style graphic image is retrieved among the graphic image storage means on the basis of the derived position with reference to the graphic image map.

Furthermore, in the graphic image retrieving system as defined in claim 27, according to the present invention, the retrieving system as set forth in claim 26, wherein the virtual space is a space of coordinate system having a first axis and a second axis perpendicular to the first axis, the first axis is assigned for amount of sense of dynamic as quantified on one axial direction and amount of sense of smart as quantified on the other direction the second axis is assigned for amount of sense of masculine c as quantified on one axial direction and amount of sense of femininity as quantified on the other direction.

With the construction set forth above, in the expression word map, sizes of sense of dynamic and sense of smart are as quantified the sensuous image of the expression word in viewpoint as positioned symmetrically and sizes of sense of masculine and sense of femininity are as quantified the sensuous image of the expression word in viewpoint as positioned symmetrically.

With the construction set forth above, in the graphic image map, sizes of sense of dynamic and sense of smart are as quantified the sensuous image of the expression word in viewpoint as positioned symmetrically and sizes of sense of masculine and sense of femininity are as quantified the sensuous image of the expression word in viewpoint as positioned symmetrically.

Here, the virtual space may be a space of the coordinate system having at least two axes. For example, it may be a space of the coordinate system having third axis perpendicular to the first axis and the second axis. In this case, the third axis is assigned the size of sense of heavy as quantified in one axis direction and size of sense of light as quantified in the other axis. As the shape of the virtual space, it is not limited to three dimensional herewith exemplified, and can be of space is greater dimension. The same is true even in the graphic image retrieving data defined in claim 30 or 32.

Furthermore, in the graphic image retrieving system as defined in claim 28, according to the present invention, the retrieving system as set forth in claim 26, wherein the virtual space is a space of coordinate system having a first axis and a second axis perpendicular to the first axis, the first axis is assigned for amount of sense of dynamic as quantified on one axial direction and amount of sense of smart as quantified on the other direction the second axis is assigned for amount of sense of heavy c as quantified on one axial direction and amount of sense of light as quantified on the other direction With the construction set forth above, in the expression word map, sizes of sense of dynamic and sense of smart are as quantified the sensuous image of the expression word in viewpoint as positioned symmetrically and sizes of sense of heavy and sense of light are as quantified the sensuous image of the expression word in viewpoint as positioned symmetrically.

With the construction set forth above, in the graphic image map, sizes of sense of dynamic and sense of smart as quantified the sensuous image of the expression word in viewpoint as positioned symmetrically and sizes of sense of heavy and sense of light are as quantified the sensuous image of the expression word in viewpoint as positioned symmetrically.

Here, the virtual space may be a space of the coordinate system having at least two axes. For example, it may be a space of the coordinate system having third axis perpendicular to the first axis and the second axis. In this case, the third axis is assigned the size of sense of masculine as quantified in one axis direction and size of sense of femininity as quantified in the other axis. As the shape of the virtual space, it is not limited to three dimensional herewith exemplified, and can be of space is greater dimension. The same is true even in the graphic image retrieving data defined in claim 30 or 32.

In order to accomplish the above-mentioned object, a graphic image retrieving program as defined in claim 29, according to the present invention, the graphic image retrieving program for retrieving graphic image of sensuous image meeting with sensuous image of retrieving word among a plurality of graphic images on the basis of a given retrieving word, comprising for a computer comprising expression word map storage means for storing an expression word map, in which a plurality of expression word expressing sensuous images of graphic images on a virtual space depending upon degree of association of those sensuous images are arranged, graphic image storage means for storing the plurality of graphic images, the program making to execute a process realized by first position deriving means for deriving the expression word corresponded to the graphic image or position of the expression word contained in each of the graphic image in the virtual space, a graphic image map generation means for generating a graphic image map arranging the respective graphic images on the virtual space on the basis of position derived at the first position deriving means, a second position deriving means for deriving position of the retrieving word on the virtual space with reference to the expression word, and graphic image retrieving means for retrieving the graphic image of sensuous image meeting with sensuous image of the retrieving word among a plurality of graphic images on the basis of the position derived at the second position deriving means with reference to the graphic image map.

With the construction set forth above, the program is read out by the computer, when the read out program is executed by the computer, the same operation as the graphic image retrieving system defined in claim 22 can be obtained.

On the other hand, in order to accomplish the above-mentioned object, a graphic image retrieving data defined in claim 30, according to the present invention, the graphic image retrieving data used by a computer retrieving hair style graphic image of sensuous image meeting with sensuous image of a retrieving word among a plurality of hair style graphic images expressing hair styles on the basis of given retrieving word, a storing expression word map, in which a plurality of expression words expressing sensuous images of hair style graphic images on a virtual space is a space of coordinate system having a first axis and a second axis perpendicular to the first axis, depending upon degree of association of the sensuous images, the first axis is assigned for amount of sense of dynamic as quantified on one axial direction and amount of sense of smart as quantified on the other direction, the second axis is assigned for amount of sense of masculine c as quantified on one axial direction and amount of sense of femininity as quantified on the other direction.

With the construction set forth above, the program is read out by the computer, when the read out program is executed by the computer, sensuous image retrieval of the hair style graphic image is performed with reference to the expression word map dedicated for the sensuous image retrieval of the hair style graphic image. For example, as applied to the graphic image retrieving system defined in claim 22 can be obtained, the equivalent operation as the graphic image retrieving system defined in claim 27.

On the other hand, in order to accomplish the above-mentioned object, a graphic image retrieving data defined in claim 31, according to the present invention, the graphic image retrieving data used by a computer retrieving hair style graphic image of sensuous image meeting with sensuous image of a retrieving word among a plurality of hair style graphic images expressing hair styles on the basis of given retrieving word, a storing expression word map, in which a plurality of expression words expressing sensuous images of hair style graphic images on a virtual space is a space of coordinate system having a first axis and a second axis perpendicular to the first axis, depending upon degree of association of the sensuous images, the first axis is assigned for amount of sense of dynamic as quantified on one axial direction and amount of sense of smart as quantified on the other direction, the second axis is assigned for amount of sense of heavy c as quantified on one axial direction and amount of sense of light as quantified on the other direction.

With the construction set forth above, the program is read out by the computer, when the read out program is executed by the computer, sensuous image retrieval of the hair style graphic image is performed with reference to the expression word map dedicated for the sensuous image retrieval of the hair style graphic image. For example, as applied to the graphic image retrieving system defined in claim 22 can be obtained, the equivalent operation as the graphic image retrieving system defined in claim 28.

Furthermore, the graphic image retrieving data defined in claim 32, according to the present invention, the graphic image retrieving data used by a computer retrieving hair style graphic image of sensuous image meeting with sensuous image of a retrieving word among a plurality of hair style graphic images expressing hair styles on the basis of given retrieving word, a storing graphic image map, in which a plurality of hair style graphic images on a virtual space is a space of coordinate system having a first axis and a second axis perpendicular to the first axis, depending upon degree of association of the sensuous images, the first axis is assigned for amount of sense of dynamic as quantified on one axial direction and amount of sense of smart as quantified on the other direction, the second axis is assigned for amount of sense of masculine c as quantified on one axial direction and amount of sense of femininity as quantified on the other direction.

With the construction set forth above, the program is read out by the computer, when the read out program is executed by the computer, sensuous image retrieval of the hair style graphic image is performed with reference to the expression word map dedicated for the sensuous image retrieval of the hair style graphic image.

Furthermore, the graphic image retrieving data defined in claim 33, according to the present invention, the graphic image retrieving data used by a computer retrieving hair style graphic image of sensuous image meeting with sensuous image of a retrieving word among a plurality of hair style graphic images expressing hair styles on the basis of given retrieving word, a storing graphic image map, in which a plurality of hair style graphic images on a virtual space is a space of coordinate system having a first axis and a second axis perpendicular to the first axis, depending upon degree of association of the sensuous images, the first axis is assigned for amount of sense of dynamic as quantified on one axial direction and amount of sense of smart as quantified on the other direction, the second axis is assigned for amount of sense of heavy c as quantified on one axial direction and amount of sense of light as quantified on the other direction

With the construction set forth above, the program is read out by the computer, when the read out program is executed by the computer, sensuous image retrieval of the hair style graphic image is performed with reference to the graphic image map dedicated for the sensuous image retrieval of the hair style graphic image.

On the other hand, a graphic image map generating method as defined in claim 34, according to the present invention, the method for generating a graphic image map to be used for a method of retrieving graphic image of sensuous image meeting with sensuous image of retrieving word among a plurality of graphic images to be retrieval objects on the basis of a given retrieving word using the graphic image map, in which a plurality of expression word expressing sensuous images of graphic images on a virtual space depending upon degree of association of those sensuous images are arranged, comprising storing an expression word map, in which a plurality of expression word expressing sensuous images of graphic images on a virtual space depending upon degree of association of those sensuous images are arranged, and storing the plurality of graphic images with correspondence to the expression words, and including a first position deriving step of deriving the expression word corresponded to the graphic image or position of the expression word contained in each of the graphic image in the virtual space, and a graphic image map generation step of generating a graphic image map arranging the respective graphic images on the virtual space on the basis of position derived at the first position deriving step.

Furthermore, in the graphic image map generating method as defined in claim 35, according to the present invention, the graphic image retrieving system as set forth in claim 34, wherein the graphic image is stored with correspondence with a graphic image describing document as descriptive text for the graphic image and describing sensuous image of the graphic image and a supplementary document including the expression word supplementing the graphic image descriptive document, the method comprises expression word extracting step of extracting the expression word from the graphic image descriptive document and the supplementary document corresponding to the graphic image with reference to the expression word map, the first position deriving step derives the position of the expression word extracted at the expression word extracting step with reference to the expression word map.

Furthermore, in the graphic image map generating method as defined in claim 36, according to the present invention, the graphic image retrieving system as set forth in claim m 35, wherein each of the graphic images is stored with correspondence with an attribute information indicative of the graphic image in addition to the graphic image descriptive object and the supplementary document.

In order to accomplish the above-mentioned object, a graphic image map generating system defined in claim 37, according to the present invention, the system for generating a graphic image map to be used for a system of retrieving graphic image of sensuous image meeting with sensuous image of retrieving word among a plurality of graphic images to be graphic images on the basis of a given retrieving word using the graphic image map, in which a plurality of expression word expressing sensuous images of graphic images on a virtual space depending upon degree of association of those sensuous images are arranged, comprising expression word storage means for storing an expression word map, in which a plurality of expression word expressing sensuous images of graphic images on a virtual space depending upon degree of association of those sensuous images are arranged, graphic image storage means for storing the plurality of graphic images with correspondence to the expression words, a first position deriving means for deriving the expression word corresponded to the graphic image or position of the expression word contained in each of the graphic image in the virtual space, and a graphic image map generation means for generating a graphic image map arranging the respective graphic images on the virtual space on the basis of position derived at the first position deriving step.

With the construction set forth above, by the first position deriving means, the position of the expression word of the graphic image storage means is derived with reference to the expression map, and by the graphic image map generating means, the graphic image map is generated on the basis of the derived position. In the graphic image map, respective hair style graphic images of the graphic image storage means is arranged in the virtual space.

Furthermore, in the graphic image retrieving system as defined in claim 38, according to the present invention, the graphic image retrieving system as set forthinclaim37, wherein the graphic image is stored with correspondence with a graphic image describing document as descriptive text for the graphic image and describing sensuous image of the graphic image and a supplementary document including the expression word supplementing the graphic image descriptive document, the system comprises expression word extracting step of extracting the expression word from the graphic image descriptive document and the supplementary document corresponding to the graphic image with reference to the expression word map, the first position deriving step derives the position of the expression word extracted at the expression word extracting step with reference to the expression word map.

With the construction set forth above, by the expression word extracting means, the expression word is extracted from the graphic image descriptive document and the supplementary document corresponding to each graphic image with reference to the expression word map, and by the first positioning means, the position of the extracted expression word in the virtual space is derived with reference to the expression word map.

Furthermore, in the graphic image retrieving system as defined in claim 39, according to the present invention, the graphic image retrieving system as set forth in claim m 38, wherein each of the graphic images is stored with correspondence with an attribute information indicative of the graphic image in addition to the graphic image descriptive object and the supplementary document.

With the construction set forth above, in the graphic image map, each graphic image in the graphic image storage means is arranged on the virtual space with correspondence to the attribute information.

As set forth above, with the retrieving method defined in claims 1 to 5 according to the present invention, upon establishing a system performing sensuous image retrieval of the retrieval object, mapping the retrieval object on the virtual space can be eliminated. Accordingly, in comparison with the prior art, sensuous image retrieval of the retrieval object relatively advantageous in view point of work load and time can be performed.

With the retrieving system defined in claims 6 to 10 according to the present invention, upon establishing a system performing sensuous image retrieval of the retrieval object, mapping the retrieval object on the virtual space can be eliminated. Accordingly, in comparison with the prior art, sensuous image retrieval of the retrieval object relatively advantageous in view point of work load and time can be performed.

With the retrieving system defined in claim 10 according to the present invention, when the attribute of the retrieval object is known in certain extent, the retrieval object can be narrowed down by providing the attribute information to make retrieval out of the desired retrieval object relatively easier.

On the other hand, with the retrieving program defined in claim 11 of the present invention, equivalent effect as the retrieving system defined in claim 6 can be obtained.

With the retrieval object map generating method defined in claims 12 to 14 according to the present invention, upon establishing a system performing sensuous image retrieval of the retrieval object, mapping the retrieval object on the virtual space can be eliminated. Accordingly, in comparison with the prior art, sensuous image retrieval of the retrieval object relatively advantageous in view point of work load and time can be performed.

With the retrieval object map generating method defined in claim 13 or 14 according to the present invention, when the all of expression words expressing the sensuous image of the retrieval object cannot be described in the retrieval object descriptive document in view of document structure by any means, the lacking expression word can be described as the supplementary document to permit arrangement of the retrieval object at relatively appropriate position in the virtual space without degradation of document structure of the descriptive text for the retrieval object.

Furthermore, with the retrieval objective map generating method as defined in claim 14 according to the present invention, for the retrieval object on generated retrieval object map, attribute information is corresponded to permit application of the generated retrieval object map in attribute information retrieval in the retrieval method defined in claim 5 and in the retrieval system defined in claim 10.

On the other hand, with the retrieval object map generating method defined in claims 15 to 17 according to the present invention, upon establishing a system performing sensuous image retrieval of the retrieval object, mapping the retrieval object on the virtual space can be eliminated. Accordingly, in comparison with the prior art, sensuous image retrieval of the retrieval object relatively advantageous in view point of work load and time can be performed.

Furthermore, with the retrieval object map generating system defined in claim 16 or 17 according to the present invention, when the all of expression words expressing the sensuous image of the retrieval object cannot be described in the retrieval object descriptive document in view of document structure by any means, the lacking expression word can be described as the supplementary document to permit arrangement of the retrieval object at relatively appropriate position in the virtual space without degradation of document structure of the descriptive text for the retrieval object.

Furthermore, with the retrieval objective map generating system as defined in claim 17 according to the present invention, for the retrieval object on generated retrieval object map, attribute information is corresponded to permit application of the generated retrieval object map in attribute information retrieval in the retrieval method defined in claim 5 and in the retrieval system defined in claim 10.

As set forth above, with the graphic image retrieving method defined in claims 18 to 21 according to the present invention, upon establishing a system performing sensuous image retrieval of the graphic image, mapping the graphic image on the virtual space can be eliminated. Accordingly, in comparison with the prior art, sensuous image retrieval of the graphic image relatively advantageous in view point of work load and time can be performed.

With the graphic image retrieving system defined in claim 21 according to the present invention, when the attribute of the graphic image is known in certain extent, the graphic image can be narrowed down by providing the attribute information to make retrieval out of the desired graphic image relatively easier.

With the graphic image retrieving system defined in claims 22 to 28, upon establishing a system performing sensuous image retrieval of the graphic image, mapping the graphic image on the virtual space can be eliminated. Accordingly, in comparison with the prior art, sensuous image retrieval of the graphic image relatively advantageous in view point of work load and time can be performed.

Furthermore, with the graphic image retrieving system defined in claims 26 to 28 according to the present invention, when the all of expression words expressing the sensuous image of the graphic image cannot be described in the graphic image descriptive document in view of document structure by any means, the lacking expression word can be described as the supplementary document to permit arrangement of the graphic image at relatively appropriate position in the virtual space without degradation of document structure of the descriptive text for the graphic image.

Furthermore, with the graphic image map generating method as defined in claim 36 according to the present invention, for the graphic image on generated graphic image map, attribute information is corresponded to permit application of the generated graphic image map in attribute information retrieval in the graphic image retrieval method defined in claim 21 and in the graphic image retrieval system defined in claim 25.

Furthermore, with the graphic image map generating system defined in claims 37 to 39 according to the present invention, when the all of expression words expressing the sensuous image of the graphic image cannot be described in the graphic image descriptive document in view of document structure by any means, the lacking expression word can be described as the supplementary document to permit arrangement of the graphic image at relatively appropriate position in the virtual space without degradation of document structure of the descriptive text for the graphic image.

Furthermore, with the graphic image map generating system as defined in claim 39 according to the present invention, for the graphic image on generated graphic image map, attribute information is corresponded to permit application of the generated graphic image map in attribute information retrieval in the graphic image retrieval method defined in claim 21 and in the graphic image retrieval system defined in claim 25.

### BRIEF DESCRIPTION OF THE DRAWINGS

FIG. 1 is a block diagram showing a construction of a computer 100, to which the present invention is applicable;

FIG. 2 is a conceptual illustration showing a virtual space 50 arranged a plurality of expression words;

FIG. 3 is an illustration showing a data structure of an expression word map 60;

FIG. 4 is an illustration showing a generation method of the expression word map 60;

FIG. 5 is an illustration showing a generation method of the expression word map 60;

FIG. 6 is an illustration showing a generation method of the expression word map 60;

FIG. 7 is an illustration showing a hair style graphic image data to be retrieval object;

FIG. 8 is an illustration showing data structure of a descriptive document table 70;

FIG. 9 is an illustration showing data structure of a graphic image correspondence table 75;

FIG. 10 is a flowchart showing an sensuous image map generating process;

FIG. 11 is a conceptual illustration showing a virtual space 50 arranged each hair style sensuous image data jpg01 to jpg09;

FIG. 12 is an illustration showing data structure of an sensuous image map 80;

FIG. 13 is a flowchart showing a retrieval process;

FIG. 14 is an illustration showing a positional relationship between a coordinate of a retrieval word in a virtual space 50 and a coordinate of each hair style sensuous image;

FIG. 15 is an illustration showing data structure of a retrieval result table;

FIG. 16 is an illustration showing data structure of a graphic image correspondence table 75;

FIG. 17 is an illustration showing data structure of a field 77a;

FIG. 18 is an illustration showing data structure of a field 77b;

FIG. 19 is an illustration showing data structure of a field 77c;

FIG. 20 is an illustration showing data structure of a field 77d;

FIG. 21 is an illustration showing data structure of a field 77e;

FIG. 22 is an illustration showing data structure of a field 77f;

FIG. 23 is a flowchart showing an sensuous image map generation process;

FIG. 24 is a flowchart showing a retrieval process;

FIG. 25 is an illustration showing data structure of the sensuous image corresponding table 75; and

FIG. 26 is a flowchart showing a retrieval process.

### DESCRIPTION OF THE PREFERRED EMBODIMENT

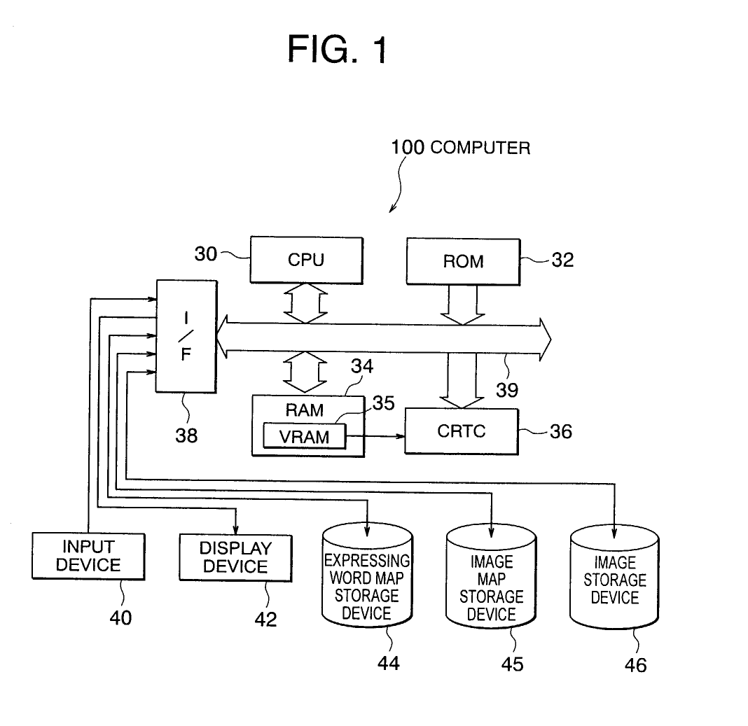

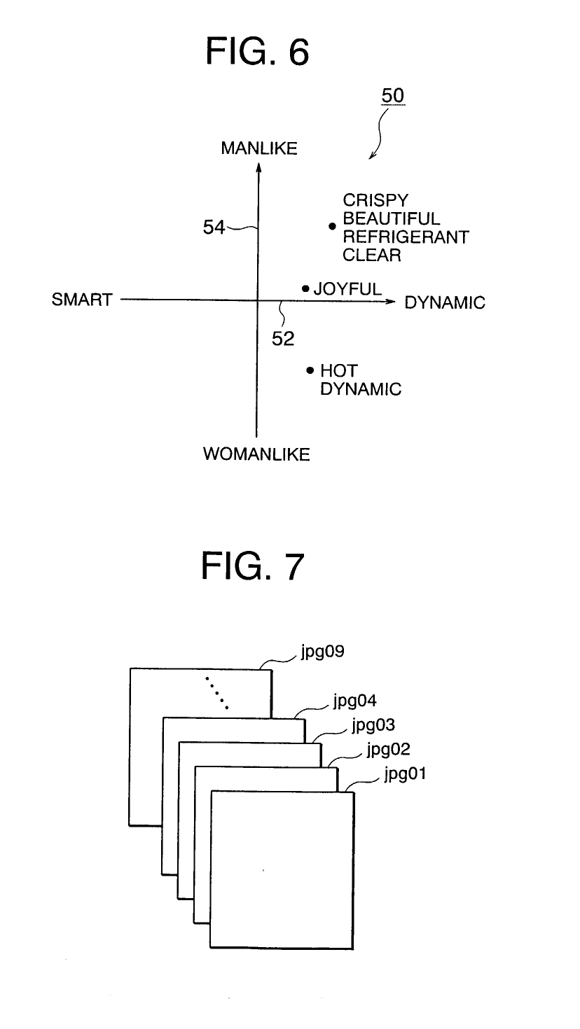

The first embodiment of the present invention will be discussed hereinafter with reference to the drawings. FIGS. 1 to 15 are illustrations showing the first embodiment of the present invention.

The shown embodiment is applied a retrieving method, a retrieving system, a retrieving program, a retrieval object map generating method, a retrieval object map generating system, an sensuous image retrieving method, an sensuous image retrieving system, an sensuous image retrieving program, an sensuous image retrieval data, an sensuous image map generating method and an sensuous image map generating system according to the present invention to the case of retrieval of hair style graphic image of the sensuous image meeting with the sensuous image of retrieval word among a plurality of hair style graphic images expressing hair styles using sensuous expression word, such as adjective, as retrieval word, by a computer 100, as shown in FIG. 1.

At first, construction of the computer 100, to which the present invention is applied, will be discussed with reference to FIG. 1. FIG. 1 is a block diagram showing a block diagram of the computer 100, to which the present invention is applied.

As shown in FIG. 1, the computer 100 is constructed with CPU 30 controlling arithmetic operation based on a control program and overall system, ROM 32 preliminarily storing the control program of CPU 30 in a predetermined region, RAM 34 for storing data read out from ROM 32 or the like and result of arithmetic operation necessary in process of operation of CPU 30, CRTC 36 outputting data stored in particular region of RAM 34 to a display device 42 with conversion into an sensuous image signal, and an I/F 38 mediating input/output of data to and from an external device. These are connected with each other via bus 39 as signal line for transferring data.

To I/F 38, an input device 40 constituted of keyboard, mouse and so forth capable of inputting data as human interface, a display device 42 for displaying a graphic image on the basis of a graphic image signal, an expression word map storage device 44 storing a plurality of expression words in an expression map arranged on a virtual space, a graphic image map storage device 45 storing a plurality of hair style graphic image data to be retrieval object arranged on a graphic image map on the virtual space, and a graphic image storage device 46 storing a plurality of hair style graphic image to be retrieval object on the virtual space.

RAM 34 has VRAM 35 storing display data to be displayed on the display device 42, as the particular region. VRAM 35 is accessible independently by CPU 30 and CRTC 36.

CRTC 36 sequentially reads out the display data stored in VRAM 35 from a leading address at a predetermined period and outputs the read out display data to the display device 42 with converting into the sensuous image signal.

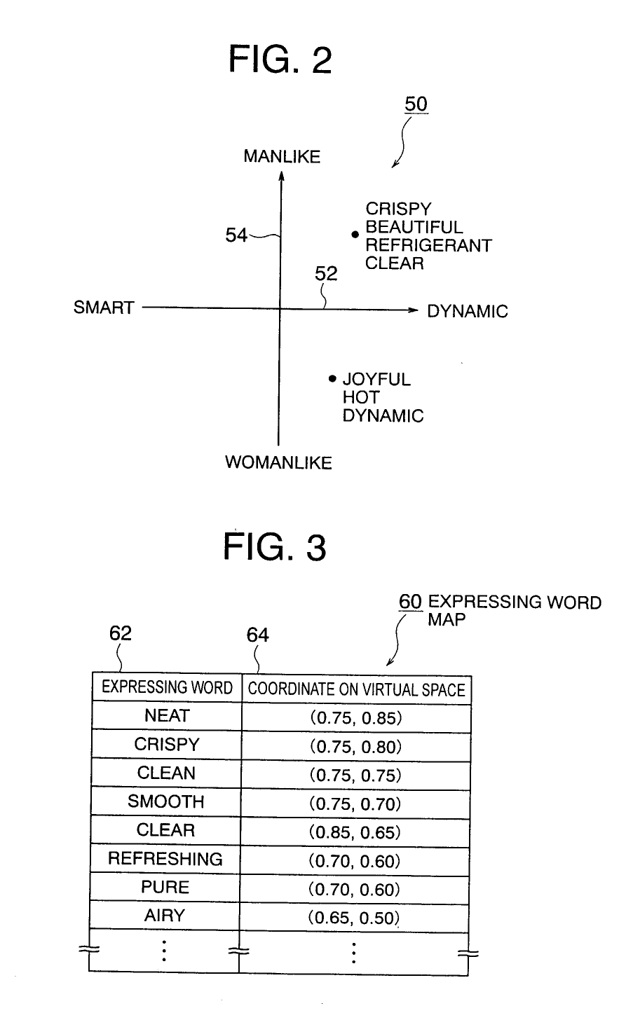

Next, data structure of the expression word map storage device 44 will be discussed with reference to FIGS. 2 and 3. FIG. 2 is a conceptual illustration showing a virtual space 50 arranged a plurality of expression words. FIG. 3 is an illustration showing a data structure of an expression word map 60.

As shown in FIG. 2, the expression word map 60 is arranges a plurality of expression words expressing sensuous images of hair style graphic images on the virtual space of the coordinate system having a first axis 52 and a second axis 54 perpendicular to the first axis 52, depending upon degree of association of those sensuous images.

The first axis 52 assigned for amount of sense of dynamic as quantified on one axial direction (right side in the drawing) and amount of sense of smart as quantified on the other direction (left side in the drawing). Namely, on the second axis, with taking an intersection with the first axis 52 as origin, sense of masculine becomes greater toward one axis direction from the origin. On the other hand, sense of femininity becomes greater toward the other axis direction from the origin.

In the example of FIG. 2, the expression words of “crispy”, “beautiful”, “refrigerant” and “clear” are arranged in the first quadrant of the virtual space 50. In the expression word map 60, these words are defined as words containing sense of masculine and dynamic. On the other hand, expression words “joy”, “hot” and “dynamic” are arranged in the fourth quadrant of the virtual space 50. With the expression word map 60, these words are defined as words containing sense of femininity and dynamic.

Next, the data structure of the expression word map 60 will be discussed in detailed with reference to FIG. 3.

As shown in FIG. 3, in the expression word map 60, one record is registered per each expression word. Each record is constructed with including a first 62 for registering the expression word and a field 64 registering coordinates of the expression word in the field 62 in the virtual space 50.

In the example of FIG. 3, in the first stage of the record, the expression word “crispy” is registered in the field 62, and the coordinates “(0.75, 0.85)” in the virtual space 50 is registered in the field 64. On the other hand, in the eighth stage records, the expression word “airy” is registered in the field 62, and the coordinates “(0.65, 0.50)” in the virtual space 50 is registered in the field 64. It should be noted that a value of the first axis 52 amount the coordinates in the virtual space 50 is positive in one axis direction of the first axis 52 with respect to the origin and negative in the other axis direction, and the value becomes greater at greater distance from the origin. On the other hand, the value on the second axis in the virtual space 50 is positive in one axis direction and negative in the other axis direction, and the value becomes greater at greater distance from the origin.

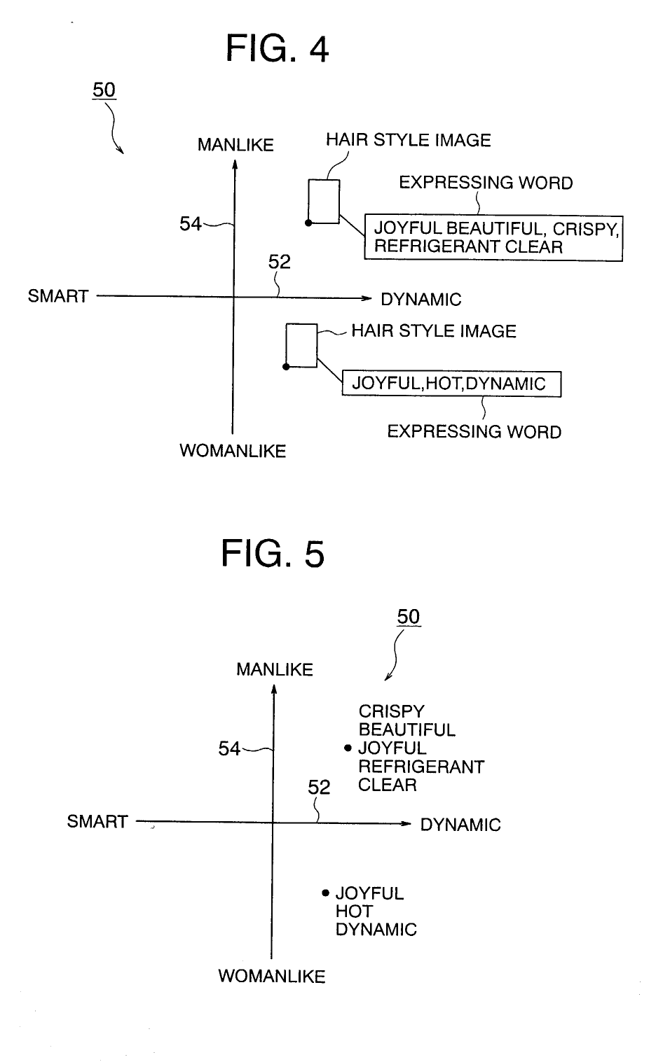

Next, detailed discussion for the generation method of the expression word map 60 will be given with reference to FIGS. 4 to 6. FIGS. 4 to 6 are illustrations showing the generation method of the expression word map 60.

The expression word map 60 is generated as follow. At first, each hair style graphic images jpg01 to jpg09 are stored with correspondence to the expression word expressing the sensuous image.

Next, as shown in FIG. 4, several typical hair style graphic image data is selected among a plurality of hair style graphic image data jpg01 to jpg09, and selected typical hairstyle graphic image data are arranged on the virtual space 50. This arrangement operation is performed manually using CAD (Computer Aided Design), for example.

As set forth above, when the typical hair style graphic image data is arranged on the virtual space 50, to the coordinate system on which the typical hair style graphic image data is arranged in the virtual space 50, the expression words corresponding to the typical hair style graphic image data is arranged. At this time, when the same expression word is arranged in a plurality of coordinates in the virtual space 50, as the coordinates of the expression words, an average coordinates of those coordinates is taken.

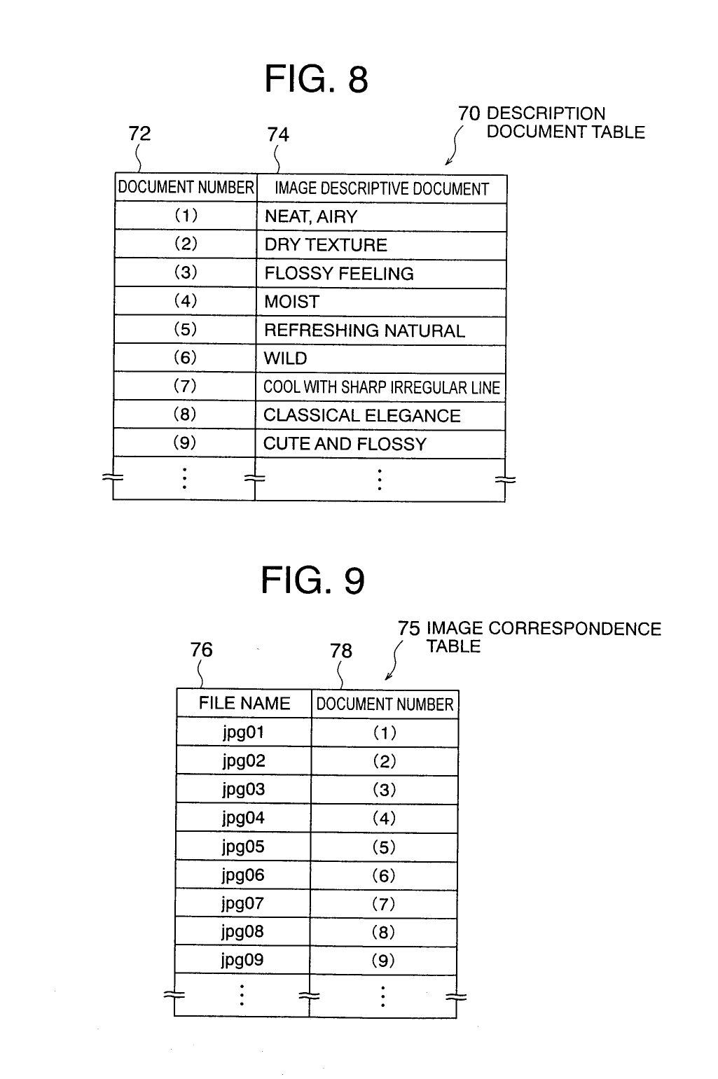

Next, data structure of the graphic image storage device 46 are discussed in detail with reference to FIGS. 7 to 9. FIG. 7 is an illustration showing a hair style graphic image data to be retrieval object, FIG. 8 is an illustration showing data structure of a descriptive document table 70 and FIG. 9 is an illustration showing data structure of a graphic image correspondence table 75.

As shown in FIGS. 7 to 9, in the graphic image storage device 46, descriptive document table 70 stores the graphic image descriptive document describing the sensuous image of the hair style graphic image data jpg01 to jpg09 and the graphic image correspondence table 75 stores correspondence between each hair style graphic image data jpg01 to jpg09 and to respective graphic image descriptive documents.

An example of FIG. 8, in the first stage record, “(1)” as document number is stored in the field 72, and “neat and airy” as graphic image descriptive document is registered in the field 74. With making reference to the expression word map 60, in this case, the graphic image descriptive documents is described using the expression words of “neat” and “airy”. On the other hand, in the fifth stage record, “(5)” is stored as document number in the field 72, and “clear and natural” is registered as graphic image descriptive document in the field 74. With making reference to the expression word map 60, in this case, the graphic image descriptive documents is described using the expression word of “clear”.

As shown in FIG. 9, the graphic image correspondence table 75 registers each hair style graphic image data jpg01 to jpg09 in each record. Each record is constructed with including a field 76 registering file name of the hair style graphic image data and a field 78 registering document number of the graphic image descriptive document corresponding to the hair style graphic image data of the field 76.

In the example of FIG. 9, in the first stage of record in the drawing, the file name “jpg01” of the hair style graphic image date jpg01 as the file name in the field 76, and “(1)” is registered as document number in the field 78. This represents hair style graphic image data jpg01 corresponds to the graphic image descriptive document “neat and airy” identified by the document number (1). On the other hand, in the fifth stage of record in the drawing, the file name “jpg05” of the hair style graphic image data jpg05 is registered in the field 76, and “(5)” is registered as the document number in the field 78. This represents hair style graphic image data jpgol corresponds to the graphic image descriptive document “crispy and natural” identified by the document number (5).

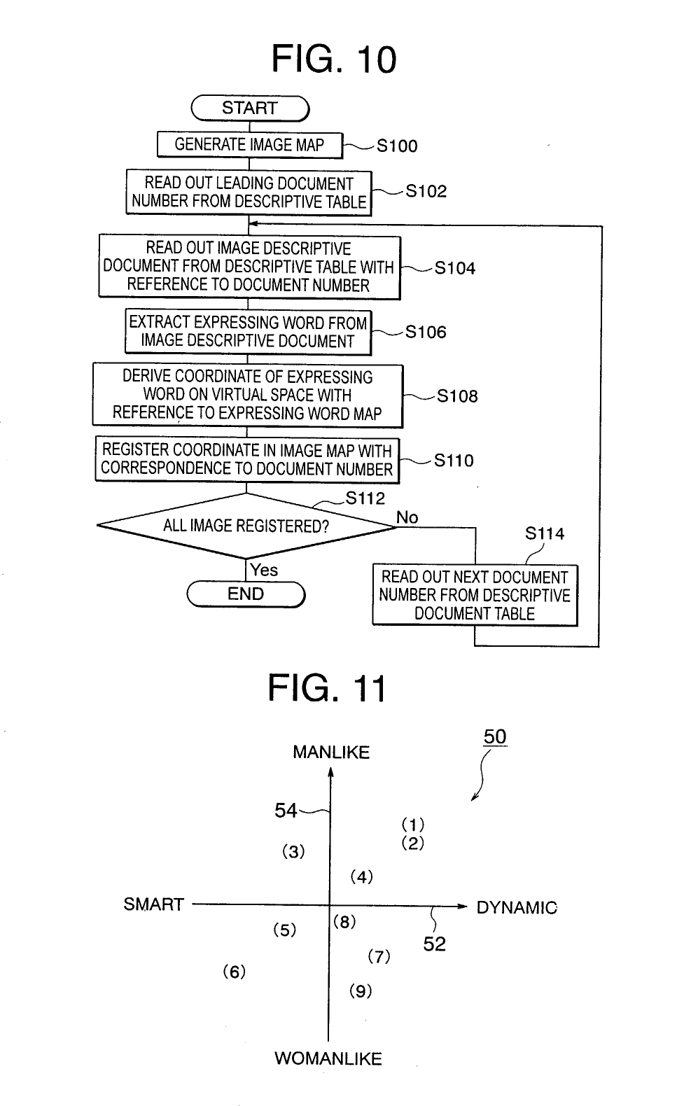

Next, construction of CPU 30 and process to be executed by CPU 30 will be discussed with reference to FIGS. 10 to 15.

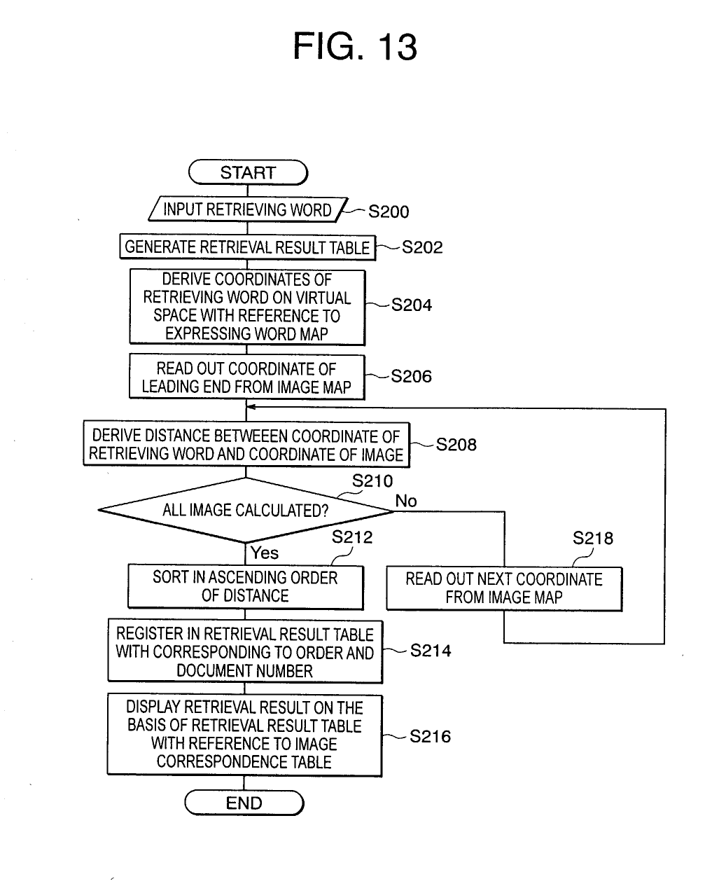

CPU 30 is constituted with a microprocessing unit MPU or the like, and a predetermined program stored in the predetermined region of ROM 32 is actuated. According to the program, image map generating process and retrieving process shown in flowcharts of FIGS. 10 and 13 are executed.

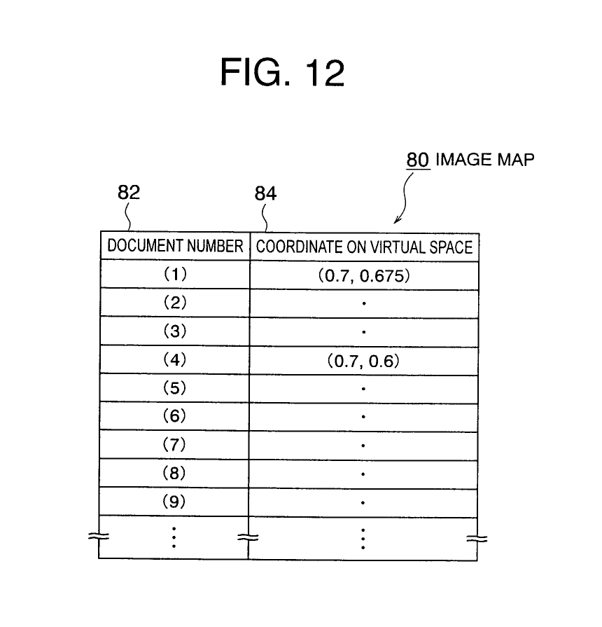

Initially, the image map generating process will be discussed in detail with reference to FIGS. 10 to 12. FIG. 10 is a flowchart showing an sensuous image map generating process, FIG. 11 is a conceptual illustration showing a virtual space 50 arranged each hair style sensuous image data jpg01 to jpg09, and FIG. 12 is an illustration showing data structure of a sensuous image map 80.

An image map generating process is a process for generating an graphic image map 80 arranging respective hair style graphic image data jpg01 to jpg09 on a virtual space 50 using the document number corresponding to the hair style graphic image and is executed in CPU 30. Then, as shown in FIG. 10, a process is advanced to step S100.

At step S100, a file for storing the content of the graphic image map 80 is generated in the graphic image map storage device 45. Then, process is advanced to step S102 to read out the document number from the leading record of the descriptive document table 70. Then, process is advanced to step S104.

At step S104, the graphic image descriptive document corresponding to the read out document number is read out from the descriptive document table 70. Then, process is advanced to step S106 to extract the expression word the same as the expression word registered in the expression word map 60 from the read out graphic image descriptive document. Thereafter, process is advanced to step S108.

At step S108, with reference to the expression word map 60, coordinates of the extracted expression word in the virtual space 50 is derived. Particularly, at step S108, the coordinates of the expression word the same as the extracted expression word among the coordinates registered in the expression word map 60, is derived as coordinate of the extracted expression word in the virtual space 50.

Next, process is advanced to step S110 to arrange respective hair style graphic image data jpg01 to jpg09 on the virtual space 50 on the basis of coordinates in the derived virtual space 50. Particularly, at step S110, the read out document number and the coordinates in the derived virtual space 50 are registered in the graphic image map with correspondence. Here, when a plurality of coordinates are derived with respect to the hair style graphic image data by including a plurality of expression words in the graphic image descriptive document, the read out document number and the average coordinates of those coordinates are registered in the graphic image map 80 with correspondence.

Accordingly, as shown in FIG. 12, in the graphic image map 80, each hair style graphic image data jpg01 to jpg09 are registered in each record. Each record is constructed with including a field 82 registering the document number corresponding to the hair style graphic image data and a field 84 recording the coordinates of the hair style graphic image data in the virtual space 50.

Next, process is advanced to step S112 to make judgment whether registering of the hair style graphic image data jpg01 to jpg09 to the graphic image map 80 is completed or not. If judgment is made that registering of all hair style graphic image data jpg01 to jpg09 in the graphic image map 80 is completed, a series of process is terminated.

On the other hand, at step S112, if judgment is made that registering of all hair style graphic image data jpg01 to jpg09 in the graphic image map 80 is not completed (NO), process is advanced to step S114 to read out the document number from the next record in the descriptive document table 70. Then, process is advanced to step S104.

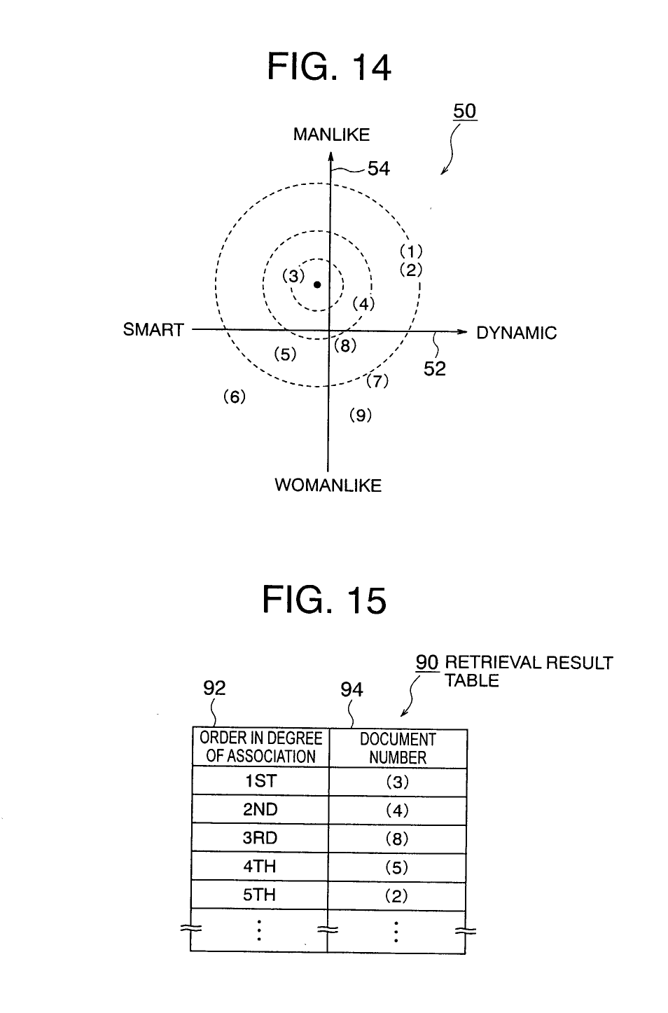

Next, retrieving process will be discussed in detail with reference to FIGS. 13 to 15. FIG. 13 is a flowchart showing a retrieval process, FIG. 14 is an illustration showing a positional relationship between a coordinate of a retrieval word in a virtual space 50 and a coordinate of each hair style sensuous image, and FIG. 15 is an illustration showing data structure of a retrieval result table.

The retrieving process is a process for retrieving the hair style graphic image having sensuous image meeting with the sensuous image of the retrieving word from the graphic image storage device 45 is executed and is executed in CPU 30 on the basis of the given retrieving word. As shown in FIG. 13, at first, process is advanced to step S200.

At step S200, the retrieving word is input from the input device40. Process isadvancedtostepS202, a file for recording the content of the retrieving result table 90 is generated in the graphic image storage device 46. Then, process is advanced to step S204.

At step S204, with reference to the expression word map 60, coordinates of the input retrieving word is derived in the virtual space 50. Particularly, at step S204, the coordinates of the expression word the same as the input retrieving word among the coordinates registered in the expression word map 60 derives the coordinates of the input retrieving word in the virtual space 50.

Next, process is advanced to step S206, the coordinates is read out from the leading record of the graphic image map 80 in the virtual space 50. Process is then advanced to step S208. As shown in FIG. 14, a distance between the coordinates of the derived retrieving word in the virtual space 50 and the coordinates of the read out hair style graphic image data in the virtual space 50, is derived. Then, process is advanced to step S210 to make judgment whether derivation of the distances is completed for all of hair style graphic image data jpg01 to jpg09. If judgment is made that derivation of the distances is completed for all of hair style graphic image data jpg01 to jpg09 (YES), process is advanced to step S212.

At step S212, the derived results at step S208 are sorted in ascending order. Then, process is advanced to step S214. Order in the derived result at step S208 as a result of sorting and the document number registered in the graphic image map 80 are corresponded to register in the retrieval result table 90 in ascending order. Then, process is advanced to step S216.

Accordingly, as shown in FIG. 15, in the retrieving result table 90, each hair style graphic image data jpg01 to jpg09 is registered in each record. These records are sorted in ascending order in the derived result at step S208. Each record is constructed with a field 92 registering the order in the result of derivation at step S208 and a field 94 registering the document number corresponding to the hair style graphic image data.

At step S216, with reference to the graphic image correspondence table 75, the retrieval result is displayed on the display device 42 on the basis of the retrieval result table 90 to terminate the sequence of process. Particularly, at step S216, the document number is read out from the leading record of the retrieval result table 90, reads out the file name from the record registering the same document number as the read out document among the record of the graphic image correspondence table 75, and displays the hair style graphic image data of the read out file name on the display device 42 with reading out from the graphic image storage device 46.

On the other hand, at step S210, if judgment is made that derivation of the distance is not completed for all of the hair style graphic image data jpg01 to jpg09 (NO), process is advanced to step S218 to read out coordinates in the virtual space 50 from the next record of the graphic image map 80. Then process is advanced to step S208.

Next, operation of the first embodiment will be discussed.

When the graphic image map 80 is generated, at first, through steps S100 to S104, the document number is read out from the leading record of the descriptive document table 70, and the graphic image descriptive document corresponding to the read out document number is read out from the descriptive document table 70.

Next, through steps S106 to S110, the expression word is extracted from the read out graphic image descriptive document. With reference to the expression word map 60, the coordinates in the virtual space of the extracted expression word is derived. The read out document number and the coordinates in the derived virtual space 50 are registered in the graphic image map 80 with correspondence.

Then, by performing the process of the steps S104 to S110 for all of the hair style graphic image data jpg01 to jpg09, respective hair style graphic image data jpg01 to jpg09 are arranged on the virtual space 50 are registered in the graphic image map 80.

When a plurality of coordinates are derived with respect to the hair style graphic image data by containing a plurality of expression word in the graphic image descriptive document, the average coordinates of those coordinates is derived as the coordinates of the hair style graphic image in the virtual space.

Next, discussion will be given for the case where the hair style graphic image of the sensuous image meeting with the sensuous image of the retrieving word is retrieved on the basis of the given retrieving word.

When the sensuous image retrieval of the hair style graphic image is performed, a person who wants to perform sensuous image retrieval (for example customer in barber shop or beauty shop) inputs the expression word (e.g. “neat”) expressing the hair style of own sensuous image, as retrieving word by the input device 40. Once the retrieving word is input, at first, through steps S200 to S204, with reference to the expression word map 60, coordinates of the input retrieving word in the virtual space 50 is derived.

Next, via steps S206 and S208, coordinates in the virtual space 50 is read out from the leading record of the graphic image map 80, the distance between the coordinates of the derived retrieving word in the virtual space 50 and the coordinates of the read out hair style graphic image in the virtual space 50 is derived.

Then, when process at step S208 is performed with respect to all of hair style graphic image data jpg01 to jpg09, the derived result at step S208 is sorted in ascending order. The order in the derived result as a result of sorting at step S208 and the document number registered in the graphic image map 80 are registered in the retrieval result table 90 in ascending order.

Then, via step S216, the document number is read out in order from the leasing recording of the retrieval result table 90. The file name is read out from the record of the document number the same as the read out document number among the record of the graphic image correspondence table 75, the hair style graphic image data of the read out file name is read out from the graphic image storage device 46 to be displayed.

In the example of FIG. 14, the coordinate of the retrieving word in the virtual space 50 is positioned in the second quadrant of the virtual space 50. In view of the coordinates of the retrieving word, the hair style graphic image data corresponding to the document number (3) is located at the closest coordinates. Therefore, this hair style graphic image data is retrieved out as the first order. In view of the coordinates of the retrieving word, the hair style graphic image data corresponding to the document number (4) is positioned on the next closest coordinates. Therefore, this hair style graphic image data is retrieved out as the second order.

Accordingly, the hair style graphic image having sensuous image matching with the sensuous image of the retrieving word is displayed. In conjunction therewith, the hair style graphic image having similar sensuous image to the sensuous image of the retrieving word is displayed.

As set forth, in the shown embodiment, a expression word map 60, in which a plurality of expression words are arranged on the virtual space 50 depending upon degree of association to those sensuous images, is stored, and respective hair style graphic image jpg01 to jpg09 are stored with correspondence to the expression words. With reference to the expression word map 60, the coordinates of the expression word corresponding to each hair style graphic image jpg01 to jpg09 is derived. The graphic image map 80, in which respective hair style graphic image jpg01 to jpg09 are arranged in the virtual space 50 on the basis of the derived coordinates, is generated. The coordinates of the retrieving word in the virtual space 50 with reference to the expression word map 60. Then, the hair style graphic image having the sensuous image meeting with the sensuous image of retrieving word among a plurality of hair style graphic images is retrieved out on the basis of the derived coordinates.

By this, upon establishing of the system for performing sensuous image retrieval of the hair style graphic image, the graphic image map 80 is not required to be prepared preliminarily to eliminate operation for mapping the hair style graphic images on the virtual space 50. Accordingly, in comparison with the prior art, sensuous image retrieval of the hair style graphic image can be performed advantageously in view point of work load and time.

On the other hand, when the process at step S108 and the process at step S204 are established as sub-routine, those processes can be made in common to facilitate finding out of bug in the program and also to contribute for shortening development time and reduction of program size.

Furthermore, in the shown embodiment, the present invention is applied for the case of retrieval of the hair style graphic image.

By this, in the barber shop and the beauty shop, the customer may relatively easily find out the desired hair style graphic image among a large number of hair style graphic images utilizing short waiting period.

Furthermore, in the shown embodiment, the virtual space 50 is a space of coordinate system having the first axis 52 and the second axis 54 perpendicular to the first axis 52. The first axis 52 assigned for amount of sense of dynamic as quantified on one axial direction and amount of sense of smart as quantified on the other direction. Namely, on the second axis 54, sense of masculine becomes greater toward one axis direction and sense of femininity becomes greater toward the other axis direction.

By this, since the hair style graphic image having the sensuous image relatively meeting with the sensuous image can be retrieved out from a plurality of hair style graphic images to facilitate retrieval of the desired hair style graphic image.

Furthermore, in the shown embodiment, respective of hair style graphic images jpg01 to jpg09 are stored with correspondence to the expression words expressing the sensuous images, and among a plurality of hair style graphic images jpg01 to jpg09, representative hair style graphic image data is selected to be representative and selected representative hair style graphic image data is arranged on the virtual space 50. In the virtual space 50, on the coordinates arranged the representative hair style graphic image data, the expression word corresponding to the representative hair style graphic image is arranged to generate the expression word map 60. At this time, when the same expression word is arranged at a plurality of coordinates in the virtual space 50, the coordinates of the expression words is set at the average coordinates of those coordinates.

By this, for generating the expression word map 60, since it is only required to arrange several hair style graphic image data on the virtual space 50, the expression word map 60 can be generated relatively easily.

In the foregoing first embodiment, the expression word map storage device 44 corresponds to expression word map storage means defined in claims 6, 11 or 15, the graphic image storage device 46 corresponds to retrieving object storage means defined in claim 6, 11 or 15, the graphic image map 80 corresponds to retrieval object map defined in claims 1, 2, 6, 7, 11, 12 or 15. On the other hand, step S108 corresponds to first position deriving step as defined in claim 1 or 12 and to first position deriving means defined in claim 6, 11 or 15, step S110 corresponds to retrieval object map generating step defined in claim 1 or 12 and to retrieval object map generating means defined in claim 6, 11 or 15.

Also, in the foregoing first embodiment, step S204 corresponds to second position deriving step defined in claim 1 or 2, and to second position deriving means defined in claim 6, 7 or 11, and steps S212 and S214 correspond to retrieval object retrieving step defined in claim 1 or 2 and retrieval object retrieving means defined in claim 6, 7 or 11.

In the first embodiment, the expression word mal storage device 44 corresponds to the expression word map storage means defined in claim 22, 29 or 37, the graphic image storage device 46 corresponds to graphic image storage means defined in claim 22, 29 or 37, step S108 corresponds to first position deriving step as defined in claim 18 or 34 and to the first position deriving means defined in claim 22, 29 or 37. On the other hand, step S110 corresponds to graphic image map generating step as defined in claim 18 or 34 and to graphic image map generating means defined in claim 22, 29 or 37, step S204 corresponds to second position deriving step defined in claim 18 or 19 and second position deriving means defined in claim 22, 23 or 29.

On the other hand, in the foregoing first embodiment, steps S212, S214 correspond to graphic image retrieving step as defined in claim 18 or 19 and to graphic image retrieving means as defined in claim 22, 23 or 29.

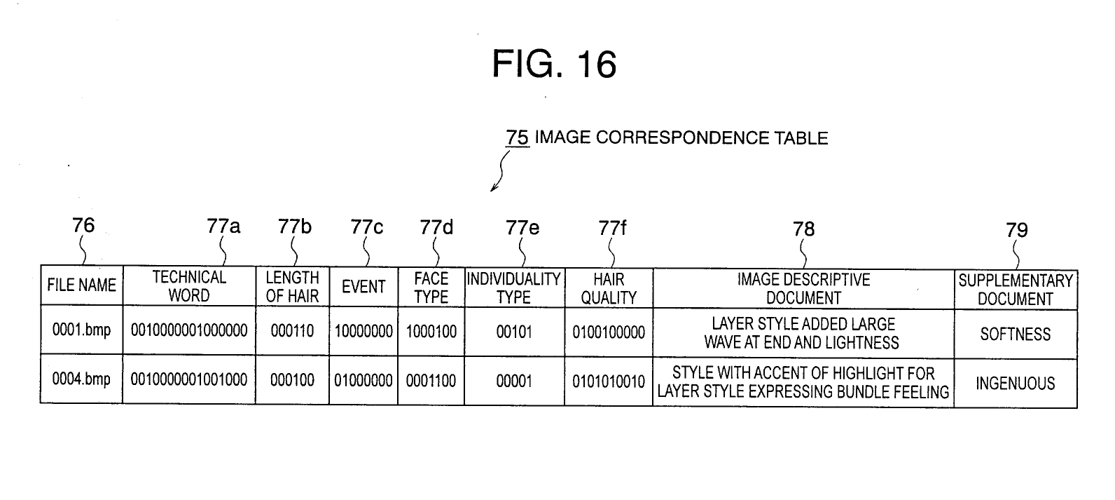

Next, the second embodiment of the present invention will be discussed with reference to the drawings. FIGS. 16 to 24 are illustrations showing the second embodiment of the present invention. It should be noted that discussion will be given hereinafter for portions different from the foregoing first embodiment, and portion common to the foregoing first embodiment will be identified by the same reference numerals and discussion therefor will be eliminated.

The shown embodiment is applied the retrieving method, the retrieving system, the retrieving program, the retrieval object map generating method, the retrieval object map generating system, then sensuous image retrieving method, the sensuous image retrieving system, the sensuous image retrieving program, the sensuous image retrieval data, the sensuous image map generating method and the sensuous image map generating system according to the present invention to the case of retrieval of hair style graphic image of the sensuous image meeting with the sensuous image of retrieval word among a plurality of hair style graphic images expressing hair styles using sensuous expression word, such as adjective, as retrieval word, by a computer 100, as shown in FIG. 1. What is different from the foregoing first embodiment is to perform attribute retrieval by attribute information showing attribute of the hair style graphic image in advance of sensuous image retrieval by the expression word.

In the foregoing first embodiment, the graphic image storage device 46 is constructed to store the descriptive document table 70 and the graphic image correspondence table 75. In place, it is possible to store the graphic image correspondence table 75 setting correspondence between the file name of the hair style graphic image, attribute information indicative of attribute of the hair style graphic image, graphic image descriptive document describing the sensuous image of the hair style graphic image and a supplementary document supplementing graphic image descriptive document, as shown in FIG. 16. FIG. 16 is an illustration showing a data construction of the graphic image correspondence table 75.

As shown in FIG. 16, in the graphic image correspondence table 75, each of hair style graphic images jpg01 to jpg09 is registered in each record. Each record is constructed with a field 76 registering the file name of the hair style graphic image data, fields 77a to 77f registering attribute information, a field 78 registering graphic image descriptive document describing sensuous image of the hair style graphic image of the field 76 and a field 79 registering the supplementary document describing the sensuous image of the hair style graphic image of the first 76.

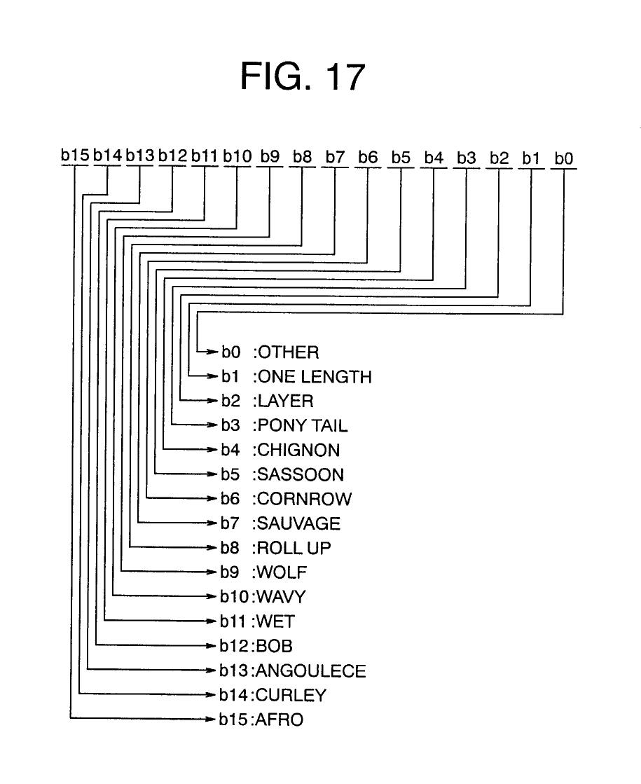

In the field 77a, as attribute information showing the first attribute of the hair style graphic image, technical words concerning hair style are registered. The technical words are consisted of fifteen attributes. Bit data of the field 77a is consisted of data of sixteen bits indicating presence and absence of each attribute by ON and OFF of bits, as shown in FIG. 17. FIG. 17 is an illustration showing data structure of the field 77a.

The bit data of the field 77 are present presence and absence of “a fro”, “curly”, “anglaise”, “bob”, “wet”, “wavy”, “wolf”, “roll up”, “sauvage”, “cornrow”, “sassoon”, “chignon”, “pony tail”, “layer”, “wine glass” and “other” in the order from the upper bit (bit at the left end in the drawing). When bit is ON, “1”, it indicates that attribute is effective, and when bit is “OFF”, “0”, it indicates that attribute is null. In the example of the first stage of record in FIG. 16, third bit and tenth bit from the most significant bit, are ON. Therefore, the hair style graphic image identified by the file name “0001.bmp” designates “anglaise” and “cornrow” as attribute of the technical word. This means the graphic image expressing the hair style of anglaise or cornrow. When the least significant bit (“other”) is ON, it means that the hair style graphic image is not designated any attribute as attribute of the technical words.

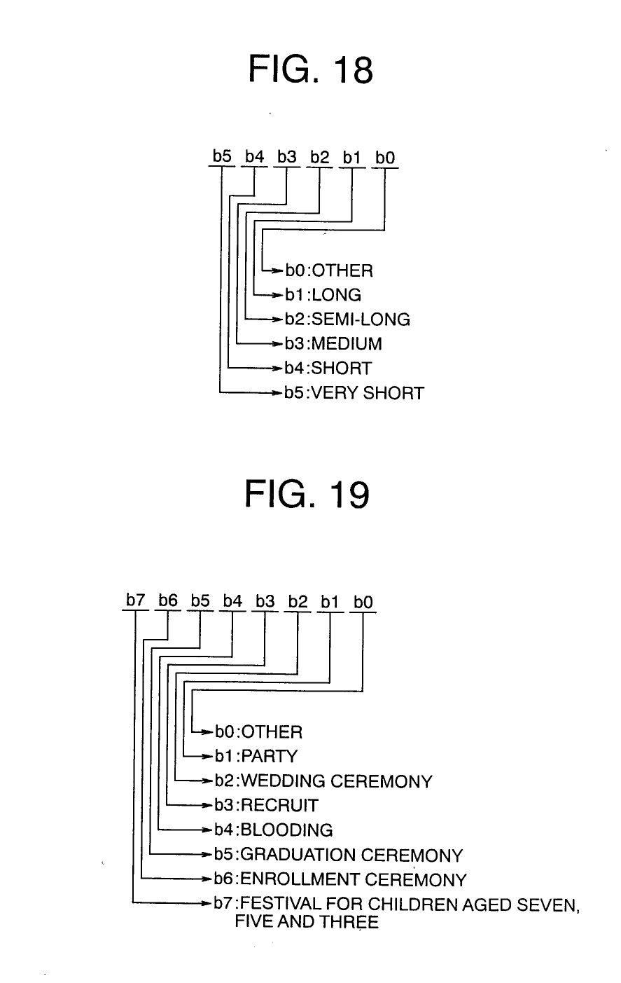

In the field 77b, as attribute information indicative of the second attribute of the hair style graphic image, length of hair is registered. The length of the hair is consisted of five attributes, and the bit data of the field 77b is consisted of data of six bits indicating presence and absence of each attribute by ON and OFF of bit. FIG. 18 is an illustration showing a data structure of field 77b.

The bit data of the field 77b indicates presence and absence of “very short”, “short”, “medium”, “semi long”, “long” and “other” in the order from the upper bit (bit at the left end in the drawing). When bit is ON, “1”, it represents the attribute is effective, and when bit is OFF, “0”, the attribute is null. In the example of the first stage of record in FIG. 16, fourth bit and fifth bit from the most significant bit, are ON. Therefore, the hair style graphic image identified by the file name “0001.bmp” designates “semi long” and “long” as attribute of length of hair. This means the graphic image expressing the hair style of semi long or long. When the least significant bit (“other”) is ON, it means that the hair style graphic image is not designated any attribute as attribute of length of hair.

In the field 77c, as attribute information indicative of third attribute of the hair style graphic image, an event suitable for the hair style is registered. The event is consisted of seven attributes. Bit data of the field 77c is consisted of eight bit data indicating presence and absence of each attribute by ON and OFF as shown in FIG. 19. FIG. 19 is an illustration showing the data structure of the field 77c.

Bit data of the field 77c represents presence and absence of “festival for children aged seven, five and three”, “entrance ceremony”, “graduation ceremony”, “coming-of-age ceremony”, “recruit”, “wedding ceremony”, “party” and “other” in the order from the upper bit (bit at the left end in the drawing). When bit is ON, “1”, it indicates that attribute is effective, and when bit is “OFF”, “0”, it indicates that attribute is null. In the example of the first stage of record in FIG. 16, first bit from the most significant bit, is ON. Therefore, the hair style graphic image identified by the file name “0001.bmp” designates “festival for children aged seven, five and three “as attribute of event. This means the graphic image expressing the hair style is suited for festival for children aged seven, five and three. When the least significant bit (“other”) is ON, it means that the hair style graphic image is not designated any attribute as attribute of event.

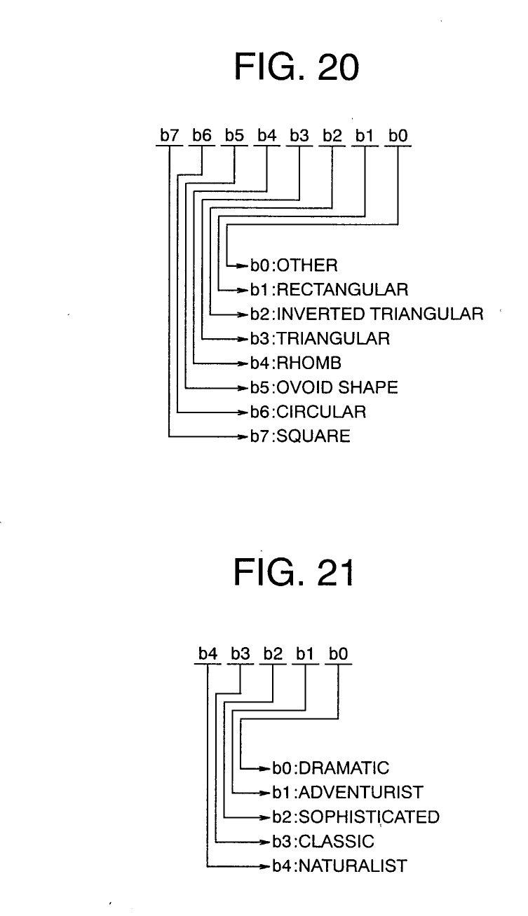

In the field 77d, as attribute information indicative of the fourth attribute of the hair style graphic image, facial form indicating shape of the face is registered. The facial form is consisted of seven attributes. Bit data of the field 77d is consisted of eight bit data indicating presence and absence of each attribute by ON and OFF as shown in FIG. 20. FIG. 20 is an illustration showing the data structure of the field 77d.

Bit data of the field 77d represents presence and absence of “square”, “round”, “ovoid shape”, “rohinbi”, “triangular”, “inverted triangular”, “rectnagular” and “other” in the order from the upper bit (bit at the left end in the drawing). When bit is ON, “1”, it indicates that attribute is effective, and when bit is “OFF”, “0”, it indicates that attribute is null. In the example of the first stage of record in FIG. 16, first bit and fifth bit from the most significant bit, is ON. Therefore, the hair style graphic image identified by the file name “0001.bmp” designates “square” and “triangular”” as attribute of facial form. This means the graphic image expressing the hair style is suited for a person having shape of the face of square or triangular. When the least significant bit (“other”) is ON, it means that the hair style graphic image is not designated any attribute as attribute of facial form.

In the field 77e, as attribute information indicative of the fifth attribute of the hair style graphic image, personal type indicative of personality type of the hair style. The personal type is consisted of five attributes. Bit data of the field 77e is consisted of five bit data indicating presence and absence of each attribute by ON and OFF as shown in FIG. 21. FIG. 21 is an illustration showing the data structure of the field 77e.

Bit data of the field 77e represents presence and absence of “naturalist”, “classic”, “sophisticated”, “adventurist”, “dramatic” and “other” in the order from the upper bit (bit at the left end in the drawing). When bit is ON, “1”, it indicates that attribute is effective, and when bit is “OFF”, “0”, it indicates that attribute is null. In the example of the first stage of record in FIG. 16, third bit and fifth bit from the most significant bit, is ON. Therefore, the hair style graphic image identified by the file name “0001.bmp” designates “naturalist” and “dramatic”” as attribute of personal type. This means the graphic image expressing the hair style is expressing a feeling of naturalist or dramatic. When the least significant bit (“other”) is ON, it means that the hair style graphic image is not designated any attribute as attribute of personal type.

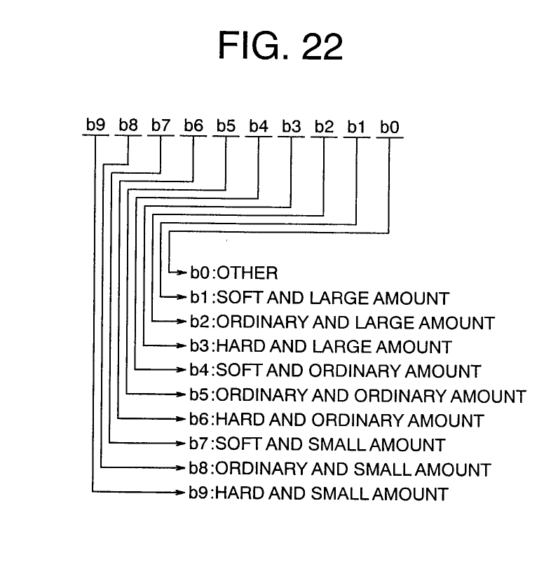

In the field 77f, as attribute information indicative of the sixth attribute of the hair style graphic image, hair property and hair amount are registered. The hair property and hair amount are consisted of nine attributes. Bit data of the field 77f is consisted of ten bit data indicating presence and absence of each attribute by ON and OFF as shown in FIG. 22. FIG. 22 is an illustration showing the data structure of the field 77f.

Bit data of the field 77f represents presence and absence of “soft and large amount”, “normal and large amount”, “hard and large amount”, “soft and medium amount”, “normal and medium amount”, “hard and medium amount”, “soft and small amount”, “normal and small amount” and “hard and small amount” and “other” in the order from the upper bit (bit at the left end in the drawing). When bit is ON, “1”, it indicates that attribute is effective, and when bit is “OFF”, “0”, it indicates that attribute is null. In the example of the first stage of record in FIG. 16, second bit and fifth bit from the most significant bit, is ON. Therefore, the hair style graphic image identified by the file name “0001.bmp” designates “soft and large amount” and “normal and medium amount” as attribute of hair property and hair amount. This means the graphic image expressing the hair style of the person having hair property slightly softer than normal and hair amount slightly larger than medium amount. When the least significant bit (“other”) is ON, it means that the hair style graphic image is not designated any attribute as attribute of hair property and hair amount.

On the other hand, returning to FIG. 16, the supplementary document describing the sensuous image of the hair style graphic image which cannot be satisfactorily described in the graphic image descriptive document. Since the graphic image descriptive document is used as descriptive text of the hair style graphic image, it is possible that all expression words expressing the sensuous image of the hair style graphic image cannot be described in view of document structure by any means. In such case, it becomes impossible to appropriately arrange the hair style graphic images on the virtual space 50. In such case, the expressing word not satisfactorily described in the graphic image descriptive document is supplemented by the supplementary document. The expression word of the supplementary document is made reference to upon arranging the hair style graphic image on the virtual space 50 similarly to the expression word in the graphic image descriptive document. It should be noted that registering to the field 79 is arbitrary, if registering of the supplementary document is not desired, it is not inherent to register.

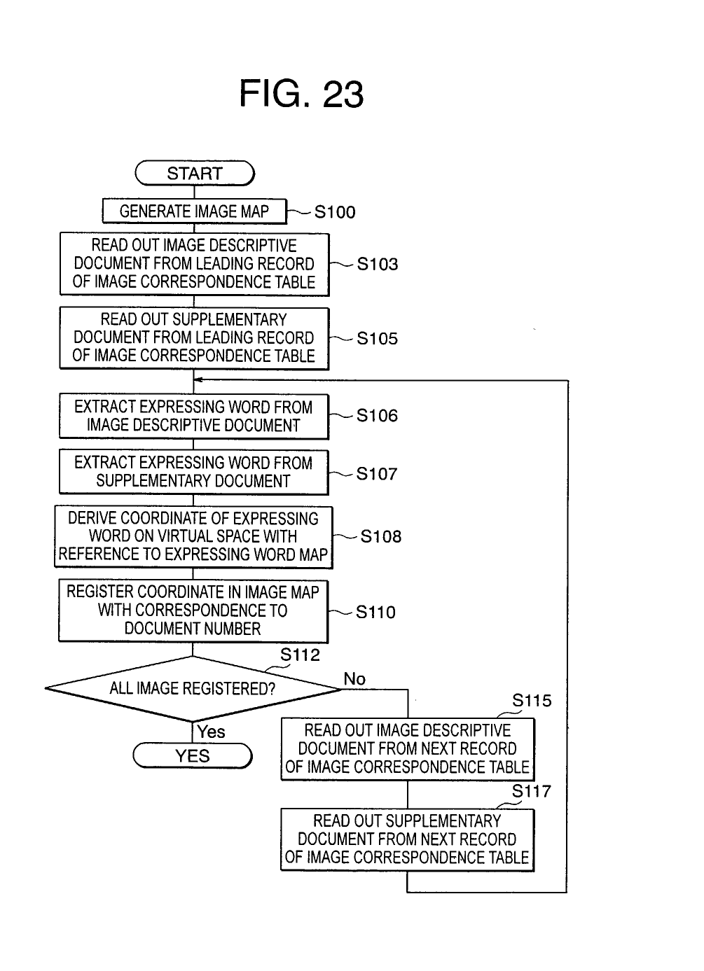

Next, graphic image map generation process will be discussed in detail with reference to FIG. 23. FIG. 23 is a flowchart showing the graphic image map generation process.

When the graphic image map generating process is executed by CPU 30, the process is at first advanced to step S100, as shown in FIG. 23.

At step S100, the file for storing the content of the graphic image map 80 is generated in the graphic image map storage device 45. Then, process is advanced to step S103 to read out the graphic image descriptive document from the leading record of the graphic image correspondence table 75. Then, process is advanced to step S105 to read out the supplementary document from the leading record of the graphic image correspondence table 75. Then, process is advanced to step S106.

At step S106, the expression word the same as the expression word registered in the expression word map 60 from the read out graphic image descriptive document. Then, process is advanced to step S107 to extract the expression word the same as the expression word registered in the expression word map 60. Thereafter, process is advanced to step S108.

At step S108, with reference to the expression word map 60, coordinates of the extracted expression word in the virtual space 50 is derived. Then, process is advanced to step S110 to arrange respective hair style graphic image data jpg01 to jpg09 on the virtual space 50 on the basis of coordinates in the derived virtual space 50. Then, process is advanced to step S112 to check whether registering of all hair style graphic image data jpg01 to jpg09 is completed or not. If judgment is made that registering of all hair style graphic image data jpg01 to jpg09 is completed (YES), a sequence of process goes end.

On the other hand, at step 112, if judgment is made that registering of all hair style graphic image data jpg01 to jpg09 to the graphic image map 80 (NO), the process is advanced to step S115 to read out the graphic image descriptive document from the next record of the graphic image correspondence table 75. Then, process is advanced to step S117, the supplementary document is read out from the next record of the graphic image correspondence table 75 to advance the process to step S106.

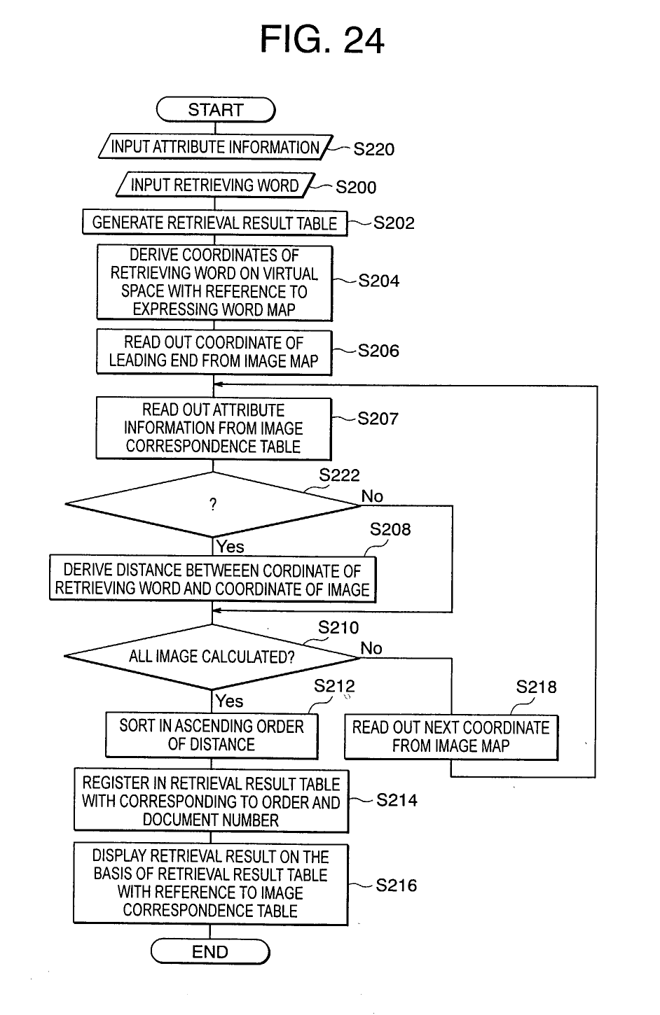

Next, retrieval process will be discussed in detail with reference to FIG. 24. FIG. 24 is a flowchart showing the retrieval process.

When the retrieval process is executed in CPU 30, the process is advanced to step S220, as shown in FIG. 24.

At step S220, attribute information (corresponding to attribute information of fields 77a to 77f) is input through the input device 40. Then, process is advanced to step S200 to input the retrieving word through the input device 40. Then, process is advanced to step S202 to generate the file for registering the content of the retrieved result table 90 in the graphic image storage device 46. Then, the process is advanced to step S204.

At step S204, with reference to the expression word map 60, coordinates of the input retrieving word is derived in the virtual space 50. Next, process is advanced to step S206, the coordinates is read out from the leading record of the graphic image map 80 in the virtual space 50. Then, the process is advanced to step S207, attribute information of the hair style graphic image identified by the document number of the leading record of the graphic image map 80 is read out from the graphic image correspondence table 75. Then, process is advanced to step S222.

At step 222, judgment is made whether the read out attribute information at step S207 and attribute information input at step S220 are matched or not. Particularly, per attribute information, OR of the read out bit data and input bit data is taken. Then, if the any one of the results of the OR derived with respect to each attribute information is not “0”, judgment is made that the read out attribute information and the input attribute information match. If the all of the results of the OR derived with respect to each attribute information are “0”, judgment is made that the read out attribute information and the input attribute information do not match. As a result of judgment, when matching is judged (YES), the process is advanced to step S208.

At step S208 a distance between the coordinates of the derived retrieving word in the virtual space 50 and the coordinates of the read out hair style graphic image data in the virtual space 50, is derived. Then, process is advanced to step S210 to make judgment whether derivation of the distances is completed for all of hair style graphic image data jpg01 to jpg09. If judgment is made that derivation of the distances is completed for all of hair style graphic image data jpg01 to jpg09 (YES), process is advanced to step S212.

At step S212, the derived results at step S208 are sorted in ascending order. Then, process is advanced to step S214. Order in the derived result at step S208 as a result of sorting and the document number registered in the graphic image map 80 are corresponded to register in the retrieval result table 90 in ascending order. Then, process is advanced to step S216. With reference to the graphic image correspondence table 75, the retrieval result is displayed on the display device 42 on the basis of the retrieval result table 90 to terminate the sequence of process.

On the other hand, at step 210, if judgment is made that derivation of the distances is not completed for all of hair style graphic image data jpg01 to jpg09 (NO), process is advanced to step S218 to read out coordinates in the virtual space 50 from the next record of the graphic image map 80. Then process is advanced to step S207.

On the other hand, at step 222, judgment is made whether the read out attribute information at step S207 and attribute information input at step S220 are not matched (NO). Process is advanced to step S210.

Next, operation of the second embodiment will be discussed.

When the graphic image map 80 is generated, at first, through steps S100 to S105, the graphic image descriptive document and the supplementary document are read out from the leading record of the graphic image correspondence table 75.

Next, through steps S106 to S110, the expression word is extracted from the read out graphic image descriptive document and the supplementary document. With reference to the expression word map 60, the coordinates in the virtual space of the extracted expression word is derived. The read out document number and the coordinates in the derived virtual space 50 are registered in the graphic image map 80 with correspondence.

Then, by performing the process of the steps S106 to S110 for all of the hair style graphic image data jpg01 to jpg09, respective hair style graphic image data jpg01 to jpg09 are arranged on the virtual space 50 are registered in the graphic image map 80.

When a plurality of coordinates are derived with respect to the hair style graphic image data by containing a plurality of expression word in the graphic image descriptive document, the average coordinates of those coordinates is derived as the coordinates of the hair style graphic image in the virtual space.

Next, discussion will be given for the case where the hair style graphic image of the sensuous image meeting with the sensuous image of the retrieving word is retrieved on the basis of the given retrieving word.

Upon performing sensuous image retrieval of the hair style graphic image, the person to perform the sensuous image retrieval (e.g. customer of the barber shop or beauty shop) inputs the input device 40 if attribute of the hair style graphic image, such as “sauvage”, “short hair”, is known in certain extent. Inputting of the attribute information is performed by entering check in the check box of the item of “sauvage” and the check box of the item of “short hair” by a mouse or the like. By this, in the computer 100, data bit indicative of the attribute of sauvage becomes ON and data bit indicative of the attribute of short hair becomes ON. Thus, inputting of the attribute information is done.

Next, a person who wants to perform sensuous image retrieval inputs the expression word (e.g. “neat”) expressing the hair style of own sensuous image, as retrieving word by the input device 40. Once the retrieving word is input, at first, through steps S220, S200 to S204, with reference to the expression word map 60, coordinates of the input retrieving word in the virtual space 50 is derived.

Next, via steps S206 and S207, coordinates in the virtual space 50 is read out from the leading record of the graphic image map 80. Attribute information of the hairstyle graphic image identified by the document number of the leading recording of the graphic image map 80 is read out from the graphic image correspondence table 75. At this time, the read out attribute information and input attribute information match, the distance between the coordinates of the derived retrieving word in the virtual space 50 and the coordinates of the read out hair style graphic image in the virtual space 50 is derived via steps S222, S228. On the other hand, if not matched, the hair style graphic image data is excluded as retrieving object.

Then, when process at step S207, S222, S208 is performed with respect to all of hair style graphic image data jpg01 to jpg09, the derived result at step S208 is sorted in ascending order via steps S212, S214. The order in the derived result as a result of sorting at step S208 and the document number registered in the graphic image map 80 are registered in the retrieval result table 90 in ascending order.

Then, via step S216, the document number is read out in order from the leasing recording of the retrieval result table 90. The file name is read out from the record of the document number the same as the read out document number among the record of the graphic image correspondence table 75, the hair style graphic image data of the read out file name is read out from the graphic image storage device 46 to be displayed.

As set forth above, in the shown embodiment, each hair style graphic image is stored with correspondence to the attribute information indicative of attribute of the hair style graphic image and retrieves the hair style graphic image corresponding to the attribute information matching with the attribute information among a plurality of hair style graphic images on the basis of the given attribute information, and derives the coordinates of the retrieving words in the virtual space with reference to the expression word map 60 and retrieves hair style graphic image of the sensuous image meeting with the sensuous image of the retrieving word among the retrieved hair style graphic images on the basis of the derived coordinates.

By this, when attribute of the hair style graphic image is known in certain extent upon retrieval, the hair style graphic images can be narrowed down by providing the attribute information to find out the desired hair style graphic image relatively easily.

Furthermore, in the shown embodiment, each hair style graphic images are stored with correspondence to the graphic image descriptive document describing sensuous image of the hair style graphic image as descriptive text for the hair style graphic image and the supplementary document including expression word supplementing the graphic image descriptive document, extracts the expression word corresponding to each hair style graphic image from the graphic image descriptive document and the supplementary document with reference to expression word map 60, derives the position in the virtual space of the extracted expression word with reference to the expression word map 60 to generate the graphic image map 80 on the basis of the derived position.

By this, when the graphic image descriptive document is used as descriptive text of the hair style graphic image, it is possible that all expression words expressing the sensuous image of the hair style graphic image cannot be described in view of document structure by any means, lacking expression words are described in the supplementary document. Then, the hair style graphic image can be appropriately positioned on the virtual space relatively appropriately without degrading document structure of the descriptive text for the hair style graphic image.

In the foregoing second embodiment, the expression word map storage device 44 corresponds to expression word map storage means defined in claims 6, 11 or 15, the graphic image storage device 46 corresponds to retrieving object storage means defined inclaim 6, 10, 11 or 5 to 17, the graphic image map 80 corresponds to retrieval object map defined in claims 1, 2, 5 to 7, 10 to 12 or 15. On the other hand, the graphic image descriptive document corresponds to retrieval object descriptive document as defined in claim 13, 14, 16 or 17, step S108 corresponds to first position deriving step as defined in claim 1 or 12 and to first position deriving means defined in claim 6, 11, 15 or 16.

On the other hand, in the foregoing second embodiment, step S110 corresponds to retrieval object map generating step defined in claim 1 or 12 and to retrieval object map generating means defined in claim 6, 11 or 15, step S204 corresponds to second position deriving step defined in claim 1, 2 or 5, and to second position deriving means defined in claim 6, 7, 10 or 11. On the other hand, steps S212 and S214 correspond to retrieval object retrieving step defined in claim 1, 2 or 5 and retrieval object retrieving means defined in claim 6, 7, 10 or 11, steps S106, S107 correspond to expression word extracting step defined in claim 13 and to expression word extracting means defined in claim 16.

In the second embodiment, the expression word mal storage device 44 corresponds to the expression word map storage means defined in claim 22, 25, 29 or37 to 39, the graphic image storage device 46 corresponds to graphic image storage means defined in claim 22, 25, 29 or 37 to 39, step S108 corresponds to first position deriving step as defined in claim 18, 34 or 35 and to the first position deriving means defined in claim 22, 29, 37 or 38. On the other hand, step S110 corresponds to graphic image map generating step as defined in claim 18 or 34 and to graphic image map generating means defined in claim 22, 29 or 37, step S204 corresponds to second position deriving step defined in claim 18, 19 or 21 and second position deriving means defined in claim 22, 23 or 29.

On the other hand, in the foregoing second embodiment, steps S212, S214 correspond to graphic image retrieving step as defined in claim 18 or 19 and to graphic image retrieving means as defined in claim 22, 23, 25 or 29, steps S106, S107 correspond to expression word extracting step defined in claim 35 and to expression word extracting means defined in claim 38.

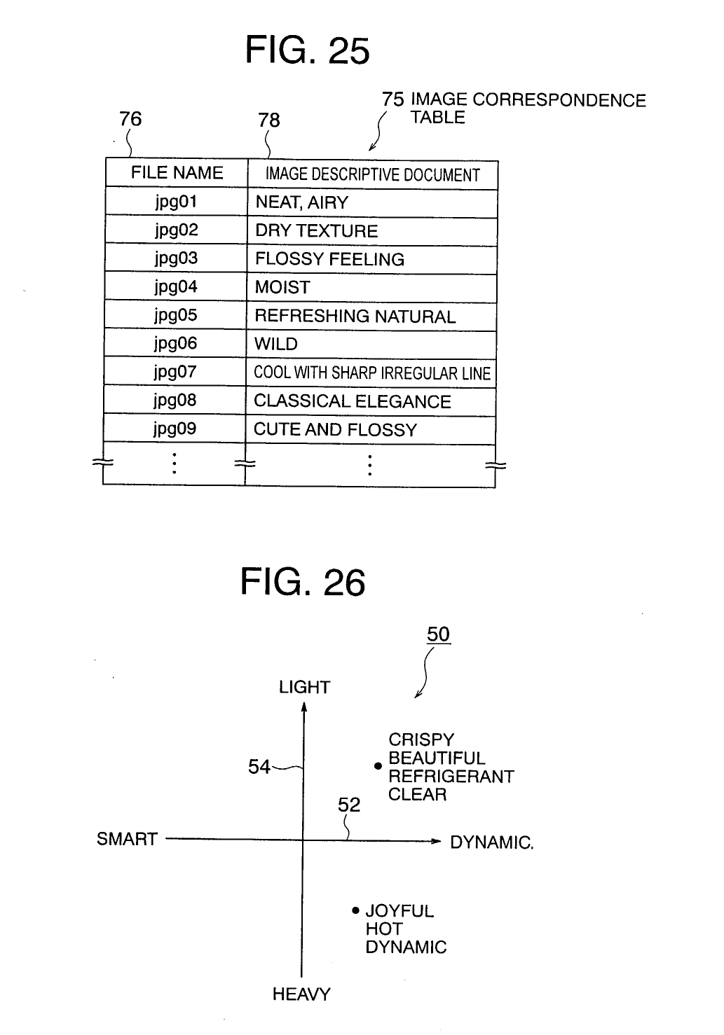

While the descriptive document table 70 and the graphic image correspondence table 75 are stored in the graphic image storage device 46 in the foregoing first and second embodiments, it is possible to store the graphic image correspondence table 75, in which the file name of the hair style graphic image data, the graphic image descriptive document describing the sensuous image of the hair style graphic image are corresponded, in place, as shown in FIG. 25. FIG. 25 is an illustration showing data structure of the graphic image correspondence table 75.

In the graphic image correspondence table 75, each hair style graphic image data jpg01 to jpg09 is registered in each record. Each record is constructed with including a field 76 registering file name of the hair style graphic image data and a field 78 registering document number of the graphic image descriptive document corresponding to the hair style graphic image data of the field 76.

In the example of FIG. 25, in the first stage of record in the drawing, the file name “jpg01” of the hair style graphic image date jpg01 is registered as the file name in the field 76, and “neat and airy” is registered as graphic image descriptive document in the field 74. On the other hand, in the fifth stage of record in the drawing, the file name “jpg05” of the hair style graphic image data jpg05 is registered in the field 76, and “crispy and natural” is registered as the graphic image descriptive document in the field 74.

Furthermore, in the first and second embodiments, the virtual space 50 is a space of coordinate system having the first axis 52 and the second axis 54 perpendicular to the first axis 52. The first axis 52 assigned for amount of sense of dynamic as quantified on one axial direction and amount of sense of smart as quantified on the other direction and on the second axis 54, sense of masculine becomes greater toward one axis direction and sense of femininity becomes greater toward the other axis direction to establish the expression word map 60 by arranging a plurality of expression words expressing the sensuous image of the hair style graphic images depending upon degree of association of the sensuous images. However, without being limited to the above, it is also possible to use the expression word map 60, in which the expression words are arranged on the virtual space 50 of the coordinate system shown in FIG. 26. FIG. 26 is a conceptual illustration showing the virtual space 50 in which a plurality of expression words are arranged.

The first axis 52 assigned for amount of sense of dynamic as quantified on one axial direction (right side in the drawing) and amount of sense of smart as quantified on the other direction (left side in the drawing). Namely, on the first axis 52, with taking an intersection with the second axis 54 as origin, sense of dynamic becomes greater toward one axis direction from the origin. On the other hand, sense of smart becomes greater toward the other axis direction from the origin.

The second axis 54 assigned for amount of sense of light as quantified on one axial direction (upper side in the drawing) and amount of sense of heavy as quantified on the other direction (lower side in the drawing). Namely, on the second axis 54, with taking an intersection with the first axis 52 as origin, sense of light becomes greater toward one axis direction from the origin. On the other hand, sense of heavy becomes greater toward the other axis direction from the origin.

In the example of FIG. 26, the expression words of “crispy”, “beautiful”, “refrigerant” and “clear” are arranged in the first quadrant of the virtual space 50. In the expression word map 60, these words are defined as words containing sense of light and dynamic. On the other hand, expression words “joy”, “hot” and “dynamic” are arranged in the fourth quadrant of the virtual space 50. With the expression word map 60, these words are defined as words containing sense of heavy and dynamic.

On the other hand, this is the same in the graphic image map 80. Namely, when the expression word map 60 takes the data structure as set forth above, the graphic image map 80 also takes similar data structure.

By this, since the hair style graphic image of the sensuous image relatively meeting with the sensuous image among a plurality of hair style graphic image can be retrieved, the desired hair style graphic image can be find out further easily.

On the other hand, in the first and second embodiments, the hair style graphic image of the coordinates having smaller distance to the coordinates of the retrieving word in ascending order. This should not be taken to be limitative and it is also possible to retrieve the hair style graphic image of the coordinates having smaller angle defined by a straight line connecting the coordinates of the retrieving word in the virtual space 50 and the origin of the virtual space 50, and a straight line connecting the coordinates of the hair style graphic image in the virtual space 50 and the origin of the virtual space 50 in ascending order.

On the virtual space 50, higher matching degree of the direction of the coordinates of the retrieving word as viewed from the origin and the direction of the coordinates of the hair style graphic image should have higher degree of association. Therefore, by retrieving such graphic image, the hair style graphic image of the sensuous image relatively meeting with the sensuous image among a plurality of hair style graphic image can be retrieved, the desired hair style graphic image can be find out.

In this case, the graphic image map 80 corresponds to retrieval object map defined in claim 3 or 8, steps S212, S214 correspond to graphic image retrieving step as defined in claim 3 and to graphic image retrieving means as defined in claim 8. Step S204 corresponds to second position deriving step defined in claim 3, and to second position deriving means defined in claim 8.

In this case, steps S212, S214 correspond to graphic image retrieving step as defined in claim 20 and to graphic image retrieving means as defined in claim 24. Step S204 corresponds to second position deriving step defined in claim 20, and to second position deriving means defined in claim 24.

On the other hand, in the foregoing first and second embodiments, each hair style graphic image jpg01 to jpg09 is stored in the graphic image storage device 46 with correspondence to the expression word. It should not be taken to be limitative and when the retrieving object is the document data, and it is possible to extract the expression word from the document data and the extracted expression word is stored with correspondence to the document data. On the other hand, without establishing correspondence of the document data to the expression word, in the process corresponding to step S106, it may be possible to extract the expression word the same as the expression word registered in the expression word map 60 from the document data to be retrieving object.

In this case, the graphic image storage device 46 corresponds to the retrieving object storage means defined in claim 9.

On the other hand, in the foregoing first and second embodiments, discussion has been given for he case where the sane hair style graphic image is mapped in the single coordinates in the virtual space 50. When a plurality of expression words are contained in the graphic image descriptive document corresponded to the hair style graphic image, the hair style graphic images are mapped in the following manner.

At first, an average is taken. For example, when the graphic image descriptive document is “crispy and artificial” and coordinates of respective expression words are assumed to be “crispy” being “(0.8, 0.7)” and “artificial” being “(0.9, -0.8)”, the coordinates of the hair style graphic image corresponding to the graphic image descriptive document becomes “(0.85, 00.05)”.

Secondly, when the coordinates of respective expression words falls within the predetermined distance, similar to the first case, the average coordinates is taken as the coordinates of the hair style graphic image similar to the first case. If distance is greater than the predetermined distance, respective coordinates are taken as the coordinates of the hair style graphic images. For example, when the graphic image descriptive document is “crispy and artificial” and coordinates of respective expression words are “crispy” being “(0.8, 0.7)” and “artificial” being “(0.9, −0.8)” and the predetermined distance is 0.5, since the distance between the coordinates is 1.5, the coordinates of the hair style graphic image becomes “(0,8, 0.7)” and “(0.9, −0.8)” with taking the average. On the other hand, when the graphic image descriptive document is “crispy and sporty” and coordinates of respective expression words are assumed as “crispy” being “(0.8, 0.7)” and “sporty” being “(0.7, 0.3)”, the distance between the coordinates is 0.4. Therefore, the coordinates of the hair style graphic image corresponding to the graphic image descriptive document becomes “(0.75, 0.5)” with taking the average. The reason is that as distance beyond the predetermined distance, degree of association is low to be expected better result of retrieval by mapping separately than that taking the average.

Thirdly, when the virtual space 50 is separated into a plurality of groups and coordinates of respective expression words belong different group, respective coordinates are taken as coordinates of the hair style graphic image, whereas as belonging the same group, the average coordinates is taken as the coordinates of the hair style graphic image similarly to the first case.

Fourthly, the first case, the second case and third case are performed in combination. Namely, the average coordinates thereof are taken as coordinates of the hair style graphic image, and respective coordinates are taken as coordinates of hair style graphic image.

On the other hand, in the foregoing first and second embodiments, discussion has bee given for the cases where the control programs preliminarily stored in ROM 32 is executed upon execution of the processes shown in the flowcharts of FIGS. 10, 13, 23 and 24, in all cases. It should not be taken to be limitative, and it is possible to execute the program indicative of these procedure stored in the storage medium by loading the program in RAM 34.

Here, the storage medium may be a semiconductor storage medium, such as ROM, RAM or the like, a magnetic storage type storage medium, such as FD, HD or the like, an optically reading type storage medium, CD, CDV, LD, DVD or the like, a magnetic storage type/optical reading type storage medium, such as MO or the like, and includes any storage medium irrespective of the reading method, electronic, magnetic, optical or the like as long as readable by computer.

On the other hand, in the foregoing first and second embodiments, the retrieving method, the retrieving system, the retrieving program, the retrieval object map generating method, the retrieval object map generating system, the image retrieving method, the image retrieving system, the image retrieving program, the image retrieval data, the image map generating method and the image map generating system according to the present invention is applied for the case of retrieval of the hair style graphic image of the sensuous image meeting with the sensuous image of the retrieving word among a plurality of hair style graphic image expressing hair styles with the computer 100 by using the sensuous expression word, such as adjective or the like, as retrieving word, as shown in FIG. 1. It should not be taken to be limitative, and it is also applicable for other cases without departing from the principle of the present invention.

For instance, it is applicable for the case of sensuous image retrieval of homepage of internet. In this case, graphic image of the home page and the document of the corresponding homepage are obtained from the internet by robotic retrieval or the like and the obtained image is stored in the graphic image storage device 46, and the obtained document is stored in the graphic image storage device as graphic image descriptive document. In many case, the expression word expressing the image of the homepage is contained in the document of the home page, application of the present invention is preferred.

On the other hand, for example, it is also applicable for the case of sensuous image retrieval of map information. In this case, on the coordinate system in the virtual space having the first axis assigned for east in one direction and for west in the other direction and the second axis assigned for north in one direction and for south in the other direction., guide information for respective spots are arranged in a sense mapping on the map of Japan. By this, for a retrieval demand such as “information of Suwa”, for example, in addition to guide information relating to Suwa, small distance between Suwa and Matsumoto is defined by the virtual space to permit retrieval of guide information of Matsumoto.

On the other hand, in the foregoing first and second embodiments, while the present invention is applied for the case to perform sensuous image retrieval of the hair style graphic image, it is not limitative and is applicable for the cases of retrieval of sensuous image retrieval of retrieving object, such as graphic image, document, music, moving picture and so forth other than hair style graphic image.

1. A method for retrieving retrieval object of sensuous image meeting with sensuous image of retrieving word among a plurality of retrieval objects on the basis of a given retrieving word, comprising:
storing an expression word map, in which a plurality of expression word expressing sensuous images of retrieval objects on a virtual space depending upon degree of association of those sensuous images are arranged, and storing said plurality of retrieval objects; and
including a first position deriving step of deriving the expression word corresponded to said retrieval object or position of the expression word contained in each of said retrieving object in said virtual space, a retrieving object map generation step of generating a retrieval object map arranging said respective retrieval objects on said virtual space on the basis of position derived at said first position deriving step, a second position deriving step of deriving position of said retrieving word on said virtual space with reference to said expression word, and retrieval object retrieving step of retrieving the retrieval object of sensuous image meeting with sensuous image of said retrieving word among a plurality of retrieval objects on the basis of the position derived at said second position deriving step with reference to said retrieval object map.

2. A retrieving method as set forth in claim 1, wherein said retrieval object retrieving step retrieves the retrieval object at a position having smaller distance to a position derived at said second position deriving step in said virtual space with reference to said retrieval object map in ascending order.

3. A retrieving method as set forth in claim 1, wherein said retrieval object retrieving step retrieves the retrieval object at a position having smaller angle defined by a straight line connecting a position in said virtual space derived by said second position deriving step and an origin of said virtual space and a straight line connecting a position of said retrieving object in said virtual space and the origin of said virtual space, with reference to said retrieval object map in ascending order.

4. A retrieving method as set forth in any one of claims 1 to 3, wherein said retrieval object is data including said expressing word, and said method comprises expression word extracting step of extracting said expression word from said retrieval object and expression word correspondence step of storing said retrieval object with correspondence with the expression word extracted in said expression word extracting step.

5. A retrieving method as set forth in any one of claims 1 to 4, wherein said retrieval objects are stored with attribute information indicative of attributes of said retrieval object,
said method comprises second retrieval object retrieving step of retrieving retrieval object corresponding to attribute information matching with a given attribute information among said plurality of retrieval objects on the basis of the given attribute information,
said retrieval object retrieving step retrieves the retrieval object of sensuous image meeting with sensuous image of said retrieving word among retrieval objects retrieved at said second retrieval object retrieving step.

6. A system for retrieving retrieval object of sensuous image meeting with sensuous image of retrieving word among a plurality of retrieval objects on the basis of a given retrieving word, comprising:
expression word map storage means for storing an expression word map, in which a plurality of expression word expressing sensuous images of retrieval objects on a virtual space depending upon degree of association of those sensuous images are arranged, retrieval object storage means for storing said plurality of retrieving objects, first position deriving means for deriving the expression word corresponded to said retrieval object or position of the expression word contained in each of said retrieving object in said virtual space, a retrieving object map generation means for generating a retrieval object map arranging said respective retrieval objects on said virtual space on the basis of position derived at said first position deriving means, a second position deriving means for deriving position of said retrieving word on said virtual space with reference to said expression word, and retrieval object retrieving means for retrieving the retrieval object of sensuous image meeting with sensuous image of said retrieving word among a plurality of retrieval objects on the basis of the position derived at said second position deriving means with reference to said retrieval object map.

7. A retrieving system as set forth in claim 6, wherein said retrieval object retrieving means retrieves the retrieval object at a position having smaller distance to a position derived at said second position deriving means in said virtual space with reference to said retrieval object map in ascending order.

8. A retrieving system as set forth in claim 6, wherein said retrieval object retrieving means retrieves the retrieval object at a position having smaller angle defined by a straight line connecting a position in said virtual space derived by said second position deriving means and an origin of said virtual space and a straight line connecting a position of said retrieving object in said virtual space and the origin of said virtual space, with reference to said retrieval object map.

9. A retrieving system as set forth in any one of claims 6 to 8, wherein said retrieval object is data including said expressing word, and
said system comprises expression word extracting means for extracting said expression word from said retrieval object and expression word correspondence means for storing said retrieval object with correspondence with the expression word extracted in said expression word extracting means.

10. A retrieving system as set forth in any one of claims 6 to 9, wherein said retrieval objects are stored with attribute information indicative of attributes of said retrieval object,
said system comprises second retrieval object retrieving means for retrieving retrieval object corresponding to attribute information matching with a given attribute information among said plurality of retrieval objects on the basis of the given attribute information,
said retrieval object retrieving means retrieves the retrieval object of sensuous image meeting with sensuous image of said retrieving word among retrieval objects retrieved by said retrieval object retrieving means.

11. A retrieving program for retrieving retrieval object of sensuous image meeting with sensuous image of retrieving word among a plurality of retrieval objects on the basis of a given retrieving word,
for a computer comprising expression word map storage means for storing an expression word map, in which a plurality of expression word expressing sensuous images of retrieval objects on a virtual space depending upon degree of association of those sensuous images are arranged, retrieval object storage means for storing said plurality of retrieving objects,
said program making to execute a process realized by first position deriving means for deriving the expression word corresponded to said retrieval object or position of the expression word contained in each of said retrieving object in said virtual space, a retrieving object map generation means for generating a retrieval object map arranging said respective retrieval objects on said virtual space on the basis of position derived at said first position deriving means, a second position deriving means for deriving position of said retrieving word on said virtual space with reference to said expression word, and retrieval object retrieving means for retrieving the retrieval object of sensuous image meeting with sensuous image of said retrieving word among a plurality of retrieval objects on the basis of the position derived at said second position deriving means with reference to said retrieval object map.

12. A method for generating a retrieval object map to be used for a method of retrieving retrieval object of sensuous image meeting with sensuous image of retrieving word among a plurality of retrieval objects on the basis of a given retrieving word using said retrieval object map, in which a plurality of expression word expressing sensuous images of retrieval objects on a virtual space depending upon degree of association of those sensuous images are arranged, comprising:
storing an expression word map, in which a plurality of expression word expressing sensuous images of retrieval objects on a virtual space depending upon degree of association of those sensuous images are arranged, and storing said plurality of retrieval objects with correspondence to said expression words; and
including a first position deriving step of deriving the expression word corresponded to said retrieval object or position of the expression word contained in each of said retrieving object in said virtual space, and a retrieving object map generation step of generating a retrieval object map arranging said respective retrieval objects on said virtual space on the basis of position derived at said first position deriving step.

13. A retrieval object map generating method as set forth in claim 12, wherein said retrieval object is stored with correspondence with a retrieval object describing document as descriptive text for said retrieval object and describing sensuous image of said retrieval object and a supplementary document including said expression word supplementing said retrieval object descriptive document,
said method comprises expression word extracting step of extracting said expression word from said retrieval object descriptive document and said supplementary document corresponding to said retrieval object with reference to said expression word map,
said first position deriving step derives the position of the expression word extracted at said expression word extracting step with reference to said expression word map.

14. A retrieval object map generating method as set forth in claim 13, wherein each of said retrieval objects is stored with correspondence with an attribute information indicative of said retrieval object in addition to said retrieval object descriptive object and said supplementary document.

15. A system for generating a retrieval object map to be used for a system of retrieving retrieval object of sensuous image meeting with sensuous image of retrieving word among a plurality of retrieval objects on the basis of a given retrieving word using said retrieval object map, in which a plurality of expression word expressing sensuous images of retrieval objects on a virtual space depending upon degree of association of those sensuous images are arranged, comprising:
expression word storage means for storing an expression word map, in which a plurality of expression word expressing sensuous images of retrieval objects on a virtual space depending upon degree of association of those sensuous images are arranged, retrieval object storage means for storing said plurality of retrieval objects with correspondence to said expression words, a first position deriving means for deriving the expression word corresponded to said retrieval object or position of the expression word contained in each of said retrieving object in said virtual space, and a retrieving object map generation means for generating a retrieval object map arranging said respective retrieval objects on said virtual space on the basis of position derived at said first position deriving step.

16. A retrieval object map generating system as set forth in claim 15, wherein said retrieval object storage means stores each of said retrieval object with correspondence with a retrieval object describing document as descriptive text for said retrieval object and describing sensuous image of said retrieval object and a supplementary document including said expression word supplementing said retrieval object descriptive document,
said system comprises expression word extracting means for extracting said expression word from said retrieval object descriptive document and said supplementary document corresponding to said retrieval object with reference to said expression word map,
said first position deriving means derives the position of the expression word extracted at said expression word extracting step with reference to said expression word map.

17. A retrieval object map generating system as set forth in claim 16, wherein each of said retrieval objects is stored with correspondence with an attribute information indicative of said retrieval object in addition to said retrieval object descriptive object and said supplementary document.

18. A method for retrieving graphic image of sensuous image meeting with sensuous image of retrieving word among a plurality of graphic images on the basis of a given retrieving word, comprising:
storing an expression word map, in which a plurality of expression word expressing sensuous images of graphic images on a virtual space depending upon degree of association of those sensuous images are arranged, and storing said plurality of graphic images; and
including a first position deriving step of deriving the expression word corresponded to said graphic image or position of the expression word contained in each of said graphic image in said virtual space, a graphic image map generation step of generating a graphic image map arranging said respective graphic images on said virtual space on the basis of position derived at said first position deriving step, a second position deriving step of deriving position of said retrieving word on said virtual space with reference to said expression word, and graphic image retrieving step of retrieving the graphic image of sensuous image meeting with sensuous image of said retrieving word among a plurality of graphic images on the basis of the position derived at said second position deriving step with reference to said graphic image map.

19. A retrieving method as set forth in claim 18, wherein said graphic image retrieving step retrieves the graphic image at a position having smaller distance to a position derived at said second position deriving step in said virtual space with reference to said graphic image map in ascending order.

20. A retrieving method as set forth in claim 18, wherein said graphic image retrieving step retrieves the graphic image at a position having smaller angle defined by a straight line connecting a position in said virtual space derived by said second position deriving step and an origin of said virtual space and a straight line connecting a position of said graphic image in said virtual space and the origin of said virtual space, with reference to said graphic image map in ascending order.

21. A retrieving method as set forth in any one of claims 18 to 20, wherein each of said graphic image is stored with correspondence with an attribute information indicative of attribute of said graphic image,
said method comprises second graphic image retrieving step of retrieving graphic image corresponding to attribute information matching with a given attribute information among said plurality of graphic images on the basis of the given attribute information,
said graphic image retrieving step retrieves the graphic image of sensuous image meeting with sensuous image of said retrieving word among graphic images retrieved at said second graphic image retrieving step.

22. A system for retrieving graphic image of sensuous image meeting with sensuous image of retrieving word among a plurality of graphic images on the basis of a given retrieving word, comprising:
expression word map storage means for storing an expression word map, in which a plurality of expression word expressing sensuous images of graphic images on a virtual space depending upon degree of association of those sensuous images are arranged, graphic image storage means for storing said plurality of graphic images, first position deriving means for deriving the expression word corresponded to said graphic image or position of the expression word contained in each of said graphic image in said virtual space, a graphic image map generation means for generating a graphic image map arranging said respective graphic images on said virtual space on the basis of position derived at said first position deriving means, a second position deriving means for deriving position of said retrieving word on said virtual space with reference to said expression word, and graphic image retrieving means for retrieving the graphic image of sensuous image meeting with sensuous image of said retrieving word among a plurality of graphic images on the basis of the position derived at said second position deriving means with reference to said graphic image map.

23. A retrieving system as set forth in claim 22, wherein said graphic image retrieving means retrieves the graphic image at a position having smaller distance to a position derived at said second position deriving means in said virtual space with reference to said graphic image map in ascending order.

24. A retrieving system as set forth in claim 22, wherein said graphic image retrieving means retrieves the graphic image at a position having smaller angle defined by a straight line connecting a position in said virtual space derived by said second position deriving means and an origin of said virtual space and a straight line connecting a position of said graphic image in said virtual space and the origin of said virtual space, with reference to said graphic image map.

25. A retrieving system as set forth in any one of claims 22 to 24, wherein said graphic images are stored with attribute information indicative of attributes of said graphic image,
said system comprises second graphic image retrieving means for retrieving graphic image corresponding to attribute information matching with a given attribute information among said plurality of graphic images on the basis of the given attribute information,
said graphic image retrieving means retrieves the graphic image of sensuous image meeting with sensuous image of said retrieving word among graphic images retrieved at said second graphic image retrieving means.

26. A retrieving method as set forth in any one of claims 22 to 25, which is applied for retrieval of hair style graphic images expressing hair styles.

27. A retrieving method as set forth in claim 26, wherein said virtual space is a space of coordinate system having a first axis and a second axis perpendicular to said first axis,
said first axis is assigned for amount of sense of dynamic as quantified on one axial direction and amount of sense of smart as quantified on the other direction
the second axis is assigned for amount of sense of masculine c as quantified on one axial direction and amount of sense of femininity as quantified on the other direction

28. A retrieving method as set forth in claim 26, wherein said virtual space is a space of coordinate system having a first axis and a second axis perpendicular to said first axis,
said first axis is assigned for amount of sense of dynamic as quantified on one axial direction and amount of sense of smart as quantified on the other direction
the second axis is assigned for amount of sense of heavy c as quantified on one axial direction and amount of sense of light as quantified on the other direction

29. A graphic image retrieving program for retrieving graphic image of sensuous image meeting with sensuous image of retrieving word among a plurality of graphic images on the basis of a given retrieving word, comprising:
for a computer comprising expression word map storage means for storing an expression word map, in which a plurality of expression word expressing sensuous images of graphic images on a virtual space depending upon degree of association of those sensuous images are arranged, graphic image storage means for storing said plurality of graphic images,
said program making to execute a process realized by first position deriving means for deriving the expression word corresponded to said graphic image or position of the expression word contained in each of said graphic image in said virtual space, a graphic image map generation means for generating a graphic image map arranging said respective graphic images on said virtual space on the basis of position derived at said first position deriving means, a second position deriving means for deriving position of said retrieving word on said virtual space with reference to said expression word, and graphic image retrieving means for retrieving the graphic image of sensuous image meeting with sensuous image of said retrieving word among a plurality of graphic images on the basis of the position derived at said second position deriving means with reference to said graphic image map.

30. A graphic image retrieving data used by a computer retrieving hair style graphic image of sensuous image meeting with sensuous image of a retrieving word among a plurality of hair style graphic images expressing hair styles on the basis of given retrieving word,
a storing expression word map, in which a plurality of expression words expressing sensuous images of hair style graphic images on a virtual space is a space of coordinate system having a first axis and a second axis perpendicular to said first axis, depending upon degree of association of the sensuous images,
said first axis is assigned for amount of sense of dynamic as quantified on one axial direction and amount of sense of smart as quantified on the other direction
the second axis is assigned for amount of sense of masculine c as quantified on one axial direction and amount of sense of femininity as quantified on the other direction.

31. A graphic image retrieving data used by a computer retrieving hair style graphic image of sensuous image meeting with sensuous image of a retrieving word among a plurality of hair style graphic images expressing hair styles on the basis of given retrieving word,
a storing expression word map, in which a plurality of expression words expressing sensuous images of hair style graphic images on a virtual space is a space of coordinate system having a first axis and a second axis perpendicular to said first axis, depending upon degree of association of the sensuous images,
said first axis is assigned for amount of sense of dynamic as quantified on one axial direction and amount of sense of smart as quantified on the other direction
the second axis is assigned for amount of sense of heavy c as quantified on one axial direction and amount of sense of light as quantified on the other direction.

32. A graphic image retrieving data used by a computer. retrieving hair style graphic image of sensuous image meeting with sensuous image of a retrieving word among a plurality of hair style graphic images expressing hair styles on the basis of given retrieving word,
a storing graphic image map, in which a plurality of hair style graphic images on a virtual space is a space of coordinate system having a first axis and a second axis perpendicular to said first axis, depending upon degree of association of the sensuous images,
said first axis is assigned for amount of sense of dynamic as quantified on one axial direction and amount of sense of smart as quantified on the other direction
the second axis is assigned for amount of sense of masculine c as quantified on one axial direction and amount of sense of femininity as quantified on the other direction.

33. A graphic image retrieving data used by a computer retrieving hair style graphic image of sensuous image meeting with sensuous image of a retrieving word among a plurality of hair style graphic images expressing hair styles on the basis of given retrieving word,
a storing graphic image map, in which a plurality of hair style graphic images on a virtual space is a space of coordinate system having a first axis and a second axis perpendicular to said first axis, depending upon degree of association of the sensuous images,
said first axis is assigned for amount of sense of dynamic as quantified on one axial direction and amount of sense of smart as quantified on the other direction
the second axis is assigned for amount of sense of heavy c as quantified on one axial direction and amount of sense of light as quantified on the other direction

34. A method for generating a graphic image map to be used for a method of retrieving graphic image of sensuous image meeting with sensuous image of retrieving word among a plurality of graphic images to be retrieval objects on the basis of a given retrieving word using said graphic image map, in which a plurality of expression word expressing sensuous images of graphic images on a virtual space depending upon degree of association of those sensuous images are arranged, comprising:
storing an expression word map, in which a plurality of expression word expressing sensuous images of graphic images on a virtual space depending upon degree of association of those sensuous images are arranged, and storing said plurality of graphic images with correspondence to said expression words; and
including a first position deriving step of deriving the expression word corresponded to said graphic image or position of the expression word contained in each of said graphic image in said virtual space, and a graphic image map generation step of generating a graphic image map arranging said respective graphic images on said virtual space on the basis of position derived at said first position deriving step.

35. A graphic image map generating method as set forth in claim 34, wherein said graphic image is stored with correspondence with a graphic image describing document as descriptive text for said graphic image and describing sensuous image of said graphic image and a supplementary document including said expression word supplementing said graphic image descriptive document,
said method comprises expression word extracting step of extracting said expression word from said graphic image descriptive document and said supplementary document corresponding to said graphic image with reference to said expression word map,
said first position deriving step derives the position of the expression word extracted at said expression word extracting step with reference to said expression word map.

36. A graphic image map generating method as set forth in claim 35, wherein each of said graphic images is stored with correspondence with an attribute information indicative of said graphic image in addition to said graphic image descriptive object and said supplementary document.

37. A system for generating a graphic image map to be used for a system of retrieving graphic image of sensuous image meeting with sensuous image of retrieving word among a plurality of graphic images to be graphic images on the basis of a given retrieving word using said graphic image map, in which a plurality of expression word expressing sensuous images of graphic images on a virtual space depending upon degree of association of those sensuous images are arranged, comprising:
expression word storage means for storing an expression word map, in which a plurality of expression word expressing sensuous images of graphic images on a virtual space depending upon degree of association of those sensuous images are arranged, graphic image storage means for storing said plurality of graphic images with correspondence to said expression words, a first position deriving means for deriving the expression word corresponded to said graphic image or position of the expression word contained in each of said graphic image in said virtual space, and a graphic image map generation means for generating a graphic image map arranging said respective graphic images on said virtual space on the basis of position derived at said first position deriving step.

38. A graphic image map generating system as set forth in claim 37, wherein said graphic image is stored with correspondence with a graphic image describing document as descriptive text for said graphic image and describing sensuous image of said graphic image and a supplementary document including said expression word supplementing said graphic image descriptive document,
said system comprises expression word extracting step of extracting said expression word from said graphic image descriptive document and said supplementary document corresponding to said graphic image with reference to said expression word map,
said first position deriving step derives the position of the expression word extracted at said expression word extracting step with reference to said expression word map.

39. A graphic image map generating system as set forth in claim 38, wherein each of said graphic images is stored with correspondence with an attribute information indicative of said graphic image in addition to said graphic image descriptive object and said supplementary document.
